(19) United States
(12) Patent Application Publication
(10) Pub. No.: US 2015/0358796 A1
(43) Pub. Date: Dec. 10, 2015

(54) Novel Alert Notification and Messaging System with Speech Recognition Capability

(71) Applicant: BIOSYNQ INC., San Francisco, CA (US)

(72) Inventor: Peter C. Sarna, II, Clayton, CA (US)

(21) Appl. No.: 14/550,913

(22) Filed: Nov. 22, 2014

Related U.S. Application Data
(63) Continuation-in-part of application No. PCT/US14/41435, filed on Jun. 6, 2014.

(51) Int. Cl. H04W 4/22; G10L 15/08; H04M 1/725; H04W 4/14; H04W 4/02

(52) U.S. Cl. CPC H04W 4/22; H04W 4/14; H04W 4/023; H04M 1/72538; G10L 15/08

(57) ABSTRACT

This disclosure pertains to an alert notification and messaging system, and in particular (but not exclusively), to techniques for generating and distributing alerts related to real-time safety and emergency incidents, having speech data contained therein, on a network of mobile devices according to proximity and subscriber rules. Systems and methods consistent with the present disclosure may also include detecting keywords spoken by a user of a mobile device during a phone call with emergency personnel. Once the phone call to emergency personnel is made, an alert is generated by the mobile device. In one or more implementations, the generated alert includes any keywords uttered during the call. The alert is transmitted to an alert server which generates and transmits an alert notification related to the incident to a network of mobile devices according to proximity and subscriber rules.

### PRIORITY

This application is a Continuation-In-Part of PCT International Application No. PCT/US14/41435 filed Jun. 6, 2014 entitled “A Novel Alert Notification and Messaging System” which is incorporated herein by reference in its entirety.

### FIELD

This disclosure pertains to an alert notification and messaging system, and in particular (but not exclusively), to techniques for generating and distributing alerts related to real-time safety and emergency incidents, having speech data contained therein, on a network of mobile devices according to proximity and subscriber rules.

### BACKGROUND

The North American Numbering Plan has assigned the telephone number 9-1-1 as the primary emergency contact number in the United States. Many other countries use similar three-digit telephone numbers to allow reporting of emergency incidents. For example, Australia uses the three-digit telephone number 0-0-0 and the European Union uses 1-1-2.

Typically, when one uses an emergency telephone number to summon emergency assistance, only public safety dispatchers and responding public safety personnel are made aware of the emergency incident in real-time. However, persons nearby the scene of the incident may have access to valuable information but may be completely unaware that an emergency situation is occurring or have limited resources to report such information.

Accordingly, a need exists to communicate the occurrence of safety and medical-related incidents in real-time and to obtain and share valuable information about such incidents to emergency agencies, law enforcement, persons nearby, family members and friends. The present disclosure addresses such a need.

### SUMMARY

The following summary is included in order to provide a basic understanding of some aspects and features of the present disclosure. This summary is not an extensive overview of the disclosure and as such it is not intended to particularly identify key or critical elements of the disclosure or to delineate the scope of the disclosure. Its sole purpose is to present some concepts of the disclosure in a simplified form as a prelude to the more detailed description that is presented below.

Systems and methods of the present disclosure pertain to alert notification systems, and in particular, to techniques for sending alerts and exchanging information during emergency incidents. Systems consistent with the present disclosure may include a plurality of mobile devices, the plurality of mobile devices include user mobile device(s) to generate an alert based on an incident, crowd-sourced-user mobile device(s) to receive a notification of the generated alert, and subscriber mobile device(s) to receive the notification of the generated alert. Systems may also include an alert server communicatively coupled to the plurality of mobile devices via a mobile alert network, the alert server to receive the generated alert from the user mobile device(s) and to send the generated alert to the crowd-source-user mobile device(s) and the subscriber mobile device(s) according to a proximity rule. The user mobile device(s) and the crowd-sourced user mobile device(s) are to send messages related to the incident to each of the plurality of mobile devices via the alert server(s) in the network. Only a subset of the crowd-sourced-user mobile devices or a subset of the subscriber mobile devices receives the notification of each generated alert. The user mobile and crowd-sourced-user mobile device(s) are to send messages related to the incident to each mobile device via the alert server(s) in the network.

Systems and methods consistent with the present disclosure may also include detecting keywords spoken by a user of a mobile device during a phone call with emergency personnel. Once the phone call to emergency personnel is made, an alert is generated by the mobile device. In one or more implementations, the generated alert includes any keywords uttered during the call. The alert is transmitted to an alert server which generates and transmits an alert notification related to the incident to a network of mobile devices according to proximity and subscriber rules.

### BRIEF DESCRIPTION OF THE DRAWINGS

To facilitate understanding, identical reference numerals have been used, where possible, to designate identical elements that are common to the drawings. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exemplary layout of several software and hardware components of a system consistent with the present disclosure.

FIG. 2 is an exemplary layout of an alert distributed through a system consistent with the present disclosure.

FIG. 3 is an exemplary layout illustrating the transmission of data when a mobile device is used to contact emergency assistance.

FIG. 4 is an exemplary mobile device display that illustrates the location of a mobile user mobile device in relation to a crowd-sourced-user mobile device.

FIG. 5 is an exemplary mobile device display that allows a mobile user to transmit and view messages related to an incident from a mobile device within a mobile alert network.

FIG. 6 is an exemplary control display that may be used by public safety personnel to monitor messages related to a crowd-sourced emergency call or other crowd-sourced alert trigger.

FIG. 7 is an exemplary control display that may be used by public safety personnel to monitor various related message groups.

FIG. 8 is an illustration of a control display of a public-service-agency user interface that enables a public service agency to create a global boundary around a location of an incident such that each mobile device within the global boundary is sent an alert or alert notification from a public agency.

FIG. 9 is yet another illustration of a control display of a public-service-agency user interface that enables a mobile user to change the global boundary.

FIG. 10 is an exemplary layout illustrating a process of generating and transmitting alert notification(s) to crowd-sourced-user mobile devices and subscriber mobile devices.

FIG. 11 is an illustration of the locations of a subscriber mobile device and crowd-sourced-user mobile devices in relation to a user mobile device that issued the alert.

FIG. 12 is an illustration of an exemplary process for generating alerts to subscriber mobile devices when a user mobile device arrives at a location where the aggregate number of crime incidents within a predetermined time period exceeds a threshold value.

FIG. 13 is an exemplary illustration of two mobile device display screenshots showing a list of subscribed user mobile devices along with the type of notifications to be received by a subscribed mobile device.

FIG. 14 is an exemplary illustration of two mobile display screenshots showing notification settings and incident type settings for a subscribed user mobile device.

FIG. 15 is an exemplary illustration of two mobile display screenshots showing an alert notification received by a crowd-sourced-user mobile device.

FIG. 16 is an exemplary layout of a process for receiving a notification of an alert at a user mobile device and in response sending an information report to an alert server and public safety systems on the mobile alert network.

FIG. 17 is an illustration of an exemplary layout showing the distribution of user data throughout a mobile alert network consistent with the present disclosure.

FIG. 18 is an exemplary illustration of an emergency alert incident record generated when a user mobile device contacts emergency assistance.

FIG. 19 is an exemplary layout of several software and hardware components which incorporate biofeedback monitoring in accordance with systems and methods in accordance with the present disclosure.

FIG. 20 is an exemplary illustration that shows the configuration of user account data in accordance with systems and methods of the present disclosure.

FIG. 21 is an illustration of an exemplary biofeedback-monitoring device consistent with systems and methods of the present disclosure.

FIG. 22 is another illustration of an exemplary biofeedback-monitoring device consistent with systems and methods of the present disclosure.

FIG. 23 is an exemplary layout illustrating various alert options in accordance with systems and methods of the present disclosure.

FIG. 24 is an exemplary layout illustrating the process of fall detection and an alert generation response from a user mobile device.

FIG. 25 is an exemplary layout illustrating the process of generating various types of alerts for fall detection in accordance with systems and methods of the present disclosure.

FIG. 26 is an exemplary layout illustrating a process of fall detection using a biofeedback-monitoring device(s) coupled to a mobile device.

FIG. 27 is an illustration of a mobile user equipped with a user mobile device having biofeedback-monitoring and fall-detection capability.

FIG. 28 is an exemplary layout of various functions to be performed in response to an incoming alert in accordance with systems and methods of the present disclosure.

FIG. 29 is an exemplary illustration of a mobile-device-alert display that may be used to evaluate and respond to alerts in accordance with systems and methods of the present disclosure.

FIG. 30 is an exemplary layout of several software and hardware components and various manners to generate alerts within a mobile alert network.

FIG. 31 is an exemplary illustration of two mobile device screenshots displaying an alert notification that has been transmitted to a crowd-sourced-user mobile device.

FIG. 32 is an illustration of a geographic boundary around a user mobile device and other mobile devices in relation to crowd-sourced-user mobile devices within a mobile alert network.

FIG. 33 is exemplary layout illustrating an alert process when a biofeedback-monitoring device generates an alert.

FIG. 34 is an exemplary illustration of two mobile device screenshots illustrating time-based alert settings associated with a fixed location.

FIG. 35 is an exemplary illustration of two mobile device screenshots illustrating time-based alert settings associated with a trip between two fixed locations.

FIG. 36 is an illustration of two mobile device screenshots illustrating a manner of sending manual alerts in accordance with systems and methods of the present disclosure.

FIG. 37 is an exemplary illustration of two mobile device screenshots of a mobile user making a 9-1-1 calls and by using a keypad and a user mobile phone that receives an alert based on the 9-1-1 call.

FIG. 38 is an exemplary illustration of two mobile device screenshots of a mobile user making a 9-1-1 call by selecting an emergency function and a user mobile phone that receives an alert based on the 9-1-1 call.

FIG. 39 is a layout illustrating the transmission of speech data, generated during a call with emergency assistance, on a network consistent with the present disclosure.

FIGS. 40A and 40B show illustrations of an interface of an alert application in operation on a mobile device displaying a public safety alert message.

FIG. 41 illustrates an interface of an alert application in operation on a mobile device used to contact emergency assistance.

FIG. 42 is an exemplary layout illustrating the transmission of data when a mobile user contacts emergency assistance via a text message function of a mobile device.

### DETAILED DESCRIPTION

A detailed description of some embodiments is provided below along with accompanying figures. The detailed description is provided in connection with such embodiments, but is not limited to any particular example. The scope is limited only by the claims and numerous alternatives, modifications, and equivalents which are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

Systems and methods consistent with the present disclosure may also include detecting keywords spoken by a user of a mobile device during a phone call with emergency personnel. Once the phone call to emergency personnel is made, an alert is generated by the mobile device. In one or more implementations, the generated alert includes any keywords uttered during the call. The alert is transmitted to an alert server which generates and transmits an alert notification related to the incident to a network of mobile devices according to proximity and subscriber rules.

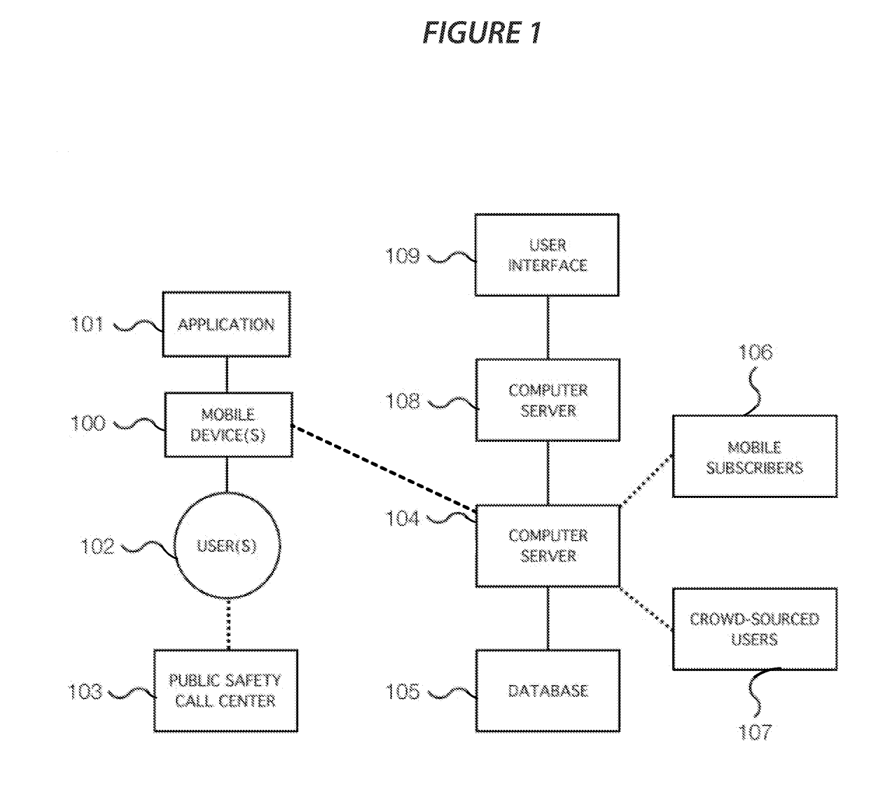

FIG. 1 is an illustration of an exemplary flowchart of several software and hardware components of a system in accordance with the present disclosure. The systems disclosed herein may include a mobile alert network of mobile device(s) 100, alert server(s) 104, 108, mobile subscribers 106, crowd-sourced-user mobile devices 107, and any other devices and computer systems which may receive or transmit alerts, alert notifications, or other messages related to an incident (e.g., emergency event).

In some implementations, the mobile device 100 is a cellular telephone, smartphone device, or any device which may be easily transported and coupled to an individual's person. In some embodiments, mobile device 100 is a cordless telephone component of a LAN line phone system.

A mobile device 100 is installed with an alert application 101 (“alert application”) that enables the mobile device 100 to communicate and share data with its telephony software. In some embodiments of the present disclosure, alert application 101 communicates and shares data with the mobile device's telephony software (not shown) using software development kits (SDKs).

The present disclosure is not limited to SDK's and therefore any method which enables the alert application 101 to share data and communicate with the mobile device's telephony software is within the spirit and scope of the present disclosure. In some embodiments alert application 101 and the mobile device's 100 telephony software application are combined into a single software application.

Mobile device 100 is capable of detecting when the mobile device's 101 telephony software contacts emergency assistance and may be further configured to automatically transmit an alert or notification alert server(s) 104 upon such event. For example, alert application 101 may be configured to transmit an alert or alert notification when user 102 makes a 9-1-1 call. One having ordinary skill in the art may appreciate that the present disclosure is not limited to generating and transmitting alerts based on a 9-1-1 call. Any manner of contacting emergency assistance may trigger an alert. In some embodiments, alert application 101 may be configured to generate and transmit alerts from various emergency assistance contacts.

Most notably, data related to contacting emergency assistance (e.g., contacting public safety call center 103) may be transmitted wirelessly to alert server(s) 104 using any suitable data transmission protocols, such as CDMA (Code Division Multiple Access), GSM (Global System for Mobile Communications), UMTS (Universal Mobile Telecommunication System), and the IP (Internet Protocol) based protocols, such as LTE, (Long Term Evolution), WiMax (Worldwide Interoperability for Microwave Access), VOLTE (Voice Over Long Term Evolution), wireless email, short message service (SMS), multimedia messaging service (MMS), satellite data transmission methods, or voice over internet protocol (VOIP).

Alert server(s) 104 may include a database 105 which has identifying information of registered mobile users 102 that have downloaded and enabled the alert application 101 on their mobile device 100. The identifying information may include the mobile user's 102 full legal name, date of birth, mobile telephone number (of the mobile device 100), any unique listed numbers associated with the mobile user's mobile device such as IMEI (International Mobile Equipment Identity), IMSI (International Mobile Subscriber Identity), ESN (Electronic Serial Number), MEID (Mobile Equipment Identifier), MAC ID (Media Access Control) mobile service provider information, mobile subscribers to the mobile user 102 or mobile user's mobile device 100, or any payment information on file for mobile user 102 and its subscribers 106. FIG. 1 also shows a secure data access portal 108 that can be accessed by authorized public safety personnel using a user interface 109 to access data from the alert server(s) 104.

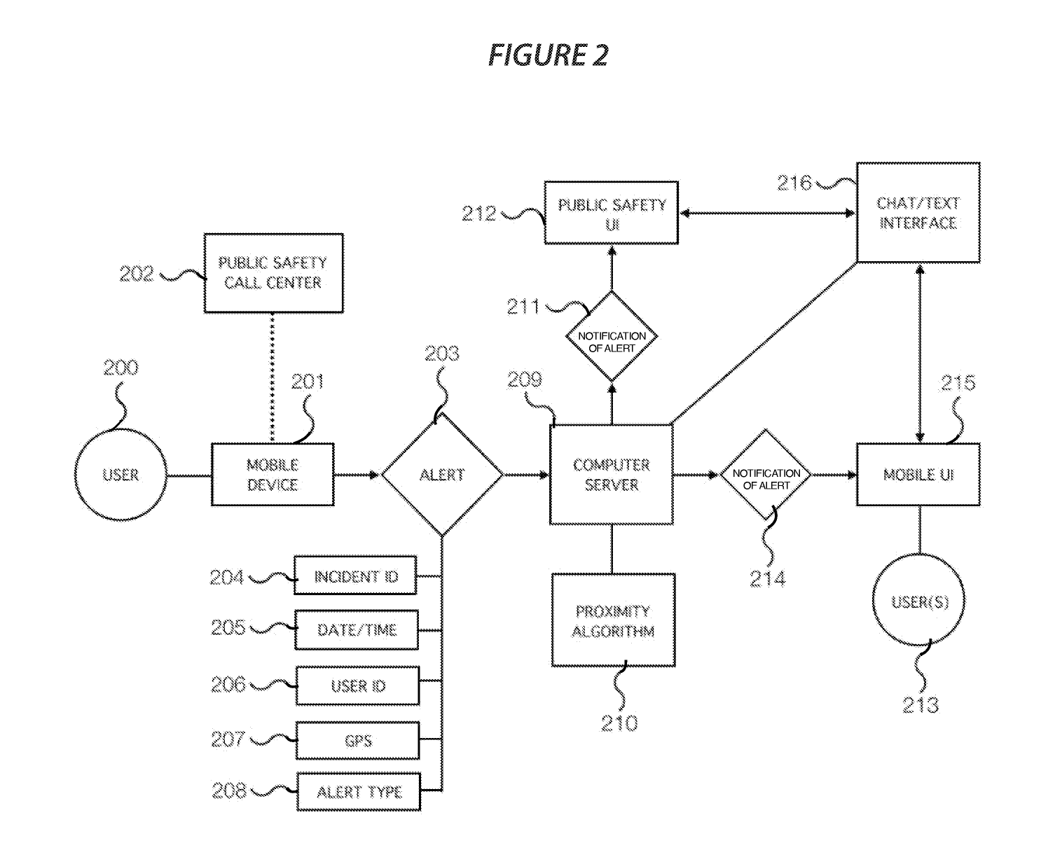

FIG. 2 is an exemplary layout of an alert distributed through a system consistent with the present disclosure. The mobile user's 200 mobile device 201 places a call to the corresponding emergency communications center 202 to summon public safety personnel (e.g., police, fire, ambulance services).

In some embodiments, when mobile user 200 contacts emergency assistance (e.g., public safety call center 202), an alert 203 and other data are transmitted to alert server(s) 209. For example, the other data may include a unique incident ID (204), a time stamp (e.g., data and time) of the alert transmission (205), mobile user's ID (206), the location of the mobile device that transmitted the alert (207) (e.g., GPS coordinates), and an alert type (208).

In addition, a proximity algorithm 210 may be executed by alert server(s) 209 to determine the emergency assistance center(s) (e.g., public safety call center 202) that is nearest to the mobile device 201 which issued the alert 203. Once the proximity algorithm 210 determines the nearest emergency assistance center, alert server 209 transmits an alert notification 211 to a public safety UI 212.

In addition, alert server(s) 209 may determine which mobile devices on the mobile alert network should receive the alert notification based on a distance from the mobile device 201 which transmitted the alert 203. In some embodiments, alert server(s) 209 transmits alert notification(s) 214 to a mobile UI 215 which forwards the alert notification(s) to other mobile device user 213. In addition, a chat/text interface 216 may be coupled to mobile UI 215 and public safety UI 212 to capture and process text data as will be described in more detail below.

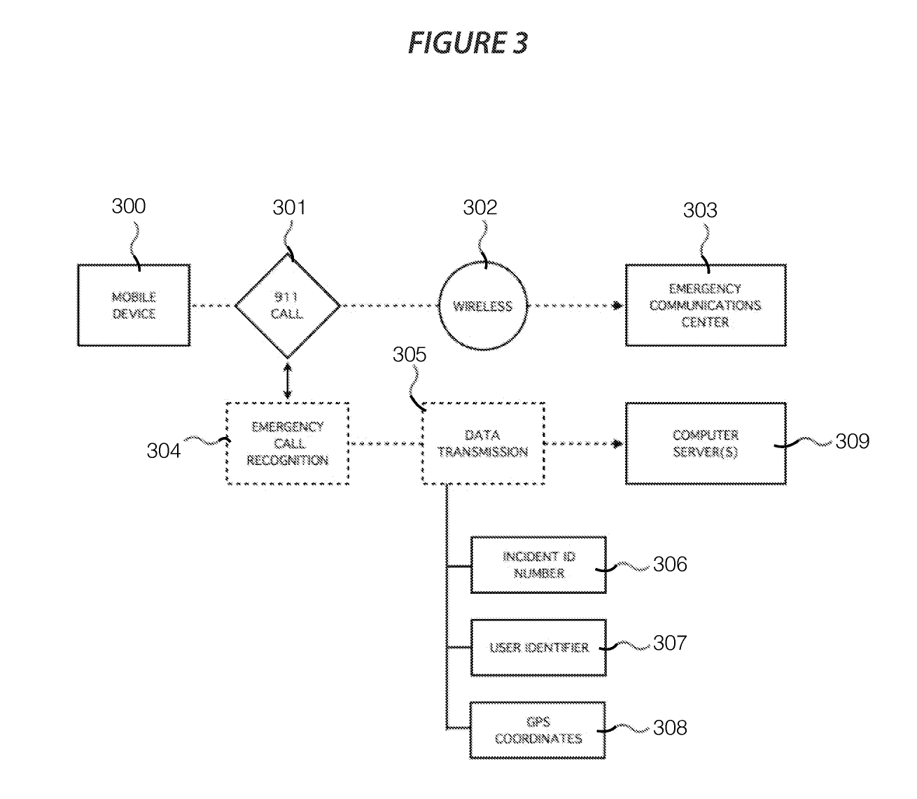

FIG. 3 is an exemplary layout illustrating the transmission of data when a mobile device 300 is used to contact emergency assistance. As shown, mobile device 300 makes a 9-1-1 telephone call 301 to an emergency communications center 303 via a wireless means 302. Advantageously, an alert application (consistent with the present disclosure) that is installed on the mobile device 300 may detect 304 the emergency call. Upon detection, the mobile device 300 transmits data 305 (e.g., incident ID number 306, user ID 307, and GPS coordinates 308) to alert server(s) 309.

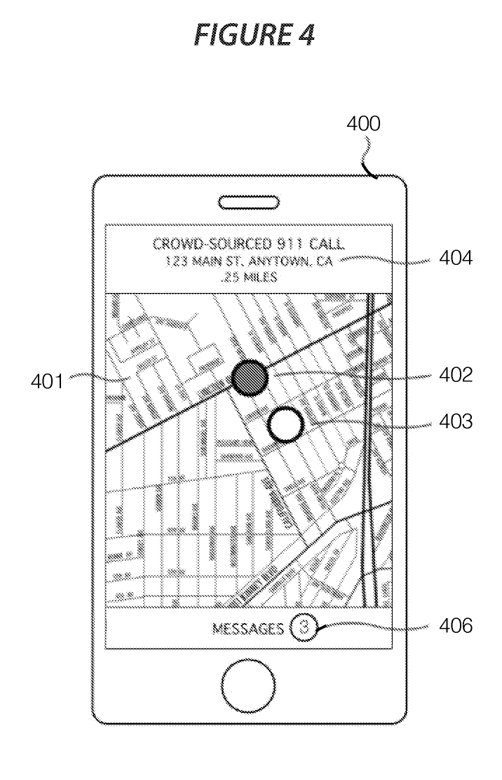

FIG. 4 is an exemplary mobile device display that illustrates the location of a user mobile device in relation to a crowd-sourced-user mobile device. As shown, a display screen of a crowd-sourced-user mobile device 400 displays a map interface 401 near the vicinity of the mobile device that transmitted the alert. In addition, icons 402, 403 of each mobile device is shown in relation to the other device on the map interface 401 so each crowd-sourced user is informed to the exact location of the mobile device that issued the alert.

Also, the crowd-sourced-user mobile device 400 displays a message indicator 406. The message indicator 406 may provide an indication of the number of messages received from a public safety agency or from another mobile device user within the mobile alert network.

Furthermore, the crowd-sourced user may use an interface mechanism to compose and send message(s) to other interface mobile users within the mobile alert network based on predefined transmission rules. The crowd-sourced-user mobile device may also receive the address of where the alert was generated along with the distance that the crowd-sourced-user-mobile phone is away from the mobile device which issued the alert.

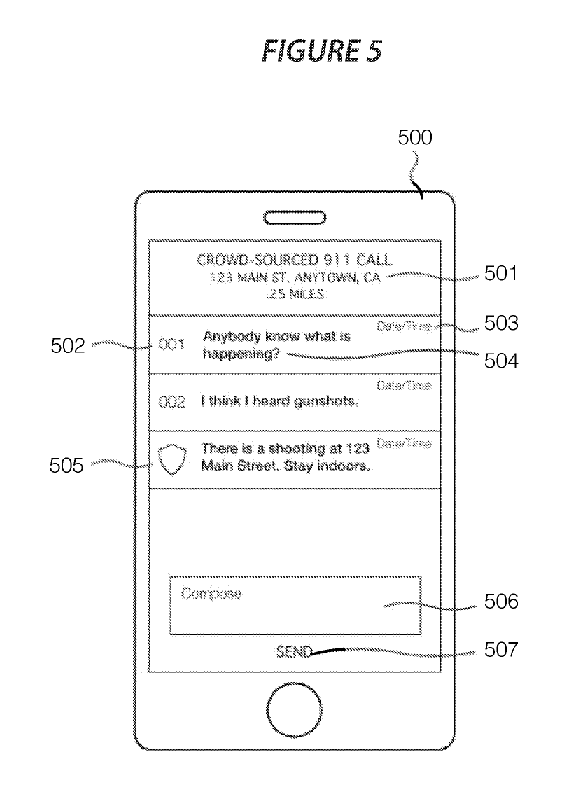

FIG. 5 is an exemplary mobile device display that allows a mobile user to transmit and view messages related to an incident from a mobile device 500 within a mobile alert network. As shown, the crowd-sourced-user mobile device 500 displays location information 501 of the mobile device that issued the alert (along with the distance from that device), the alert type generated, and the timestamp 503 of the generated alert. Advantageously, a crowd-sourced user may view the messages 504 sent related to the incident. For each message 504, an alphanumeric identifier 502 may be assigned to indicate a specific mobile user that transmitted the message 504. In particular, a special identifier 505 may indicate that the message 504 was sent by public safety agency.

Messages may be composed 506 and transmitted 507 to mobile devices throughout the mobile alert network. Accordingly, crowd-sourced-user mobile devices may both receive and transmit alert notifications throughout the network.

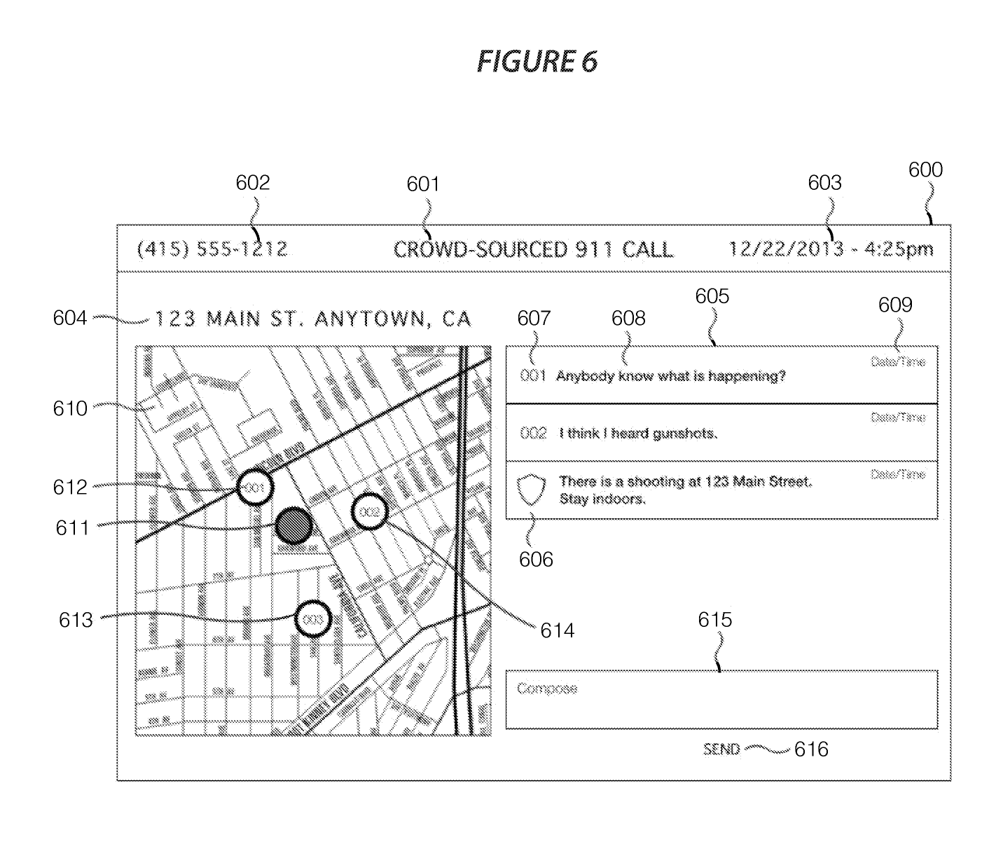

FIG. 6 is an exemplary control display 600 that may be used by public safety personnel to monitor messages related to a crowd-sourced emergency call or other crowd-sourced alert trigger. The control display 600 displays a comprehensive view of the mobile alert network as it relates to the generated alerts related to a specific incident. In addition, the control display 600 displays the alert type 601, the mobile telephone number 602 of the mobile user who generated the alert, the timestamp of the alert 603, and the street address 604 of the mobile device when the alert was generated. Control display 600 may also include some of the message features (605-609, 615, and 616) present on the crowd-sourced-user mobile interface (see FIGS. 4 and 5).

Control display 600 features a map interface 610 which shows icon 612-614 of crowd-sourced-user mobile devices in relation to the user mobile device 611 that issued the alert. Each icon 611-614 may also include a unique alphanumeric identifier (001, 002, and 003) that corresponds to an identifier 607 displayed in the messaging interface.

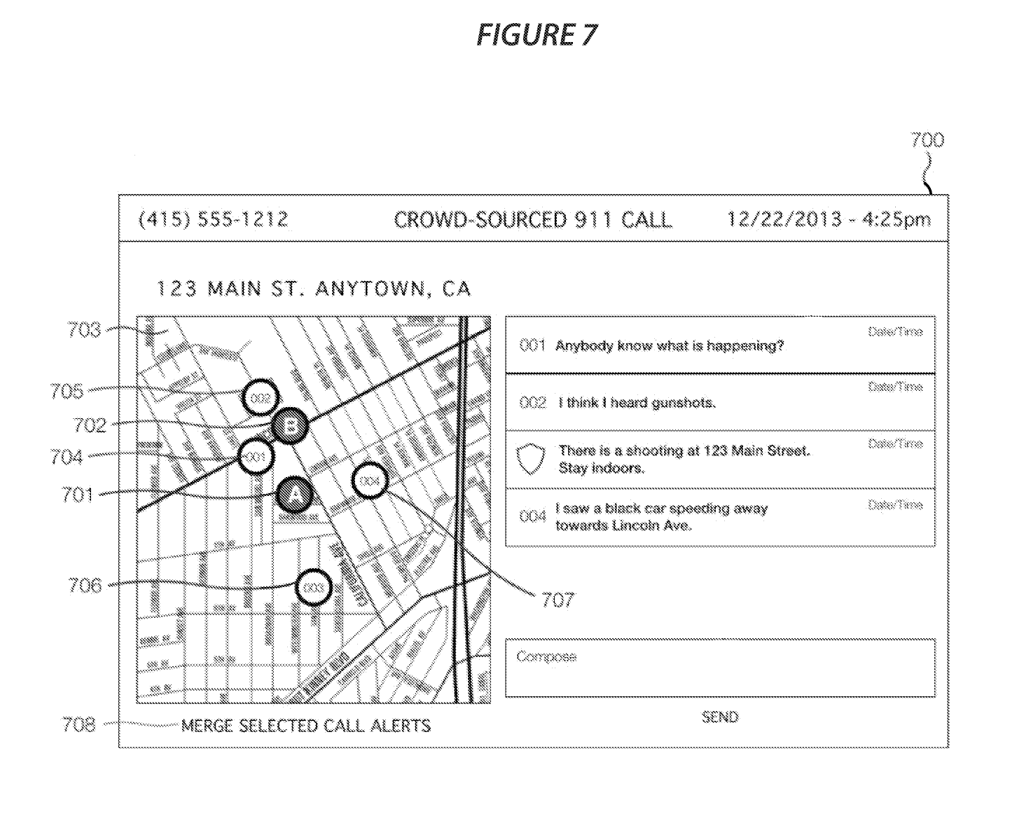

FIG. 7 is an exemplary control display 700 that may be used by public safety personnel to monitor various related message groups. In the embodiment shown, the locations of two different mobile users (A) 701, (B) 702, each of which generated alerts related to the same incident, are shown on the display's map interface 703.

In particular, the locations of crowd-sourced-user mobile devices 704, 705 that received an alert notification issued by mobile user (B) 702 are shown in relation to the location of mobile user (B) 702. In addition, the locations of crowd-sourced-user mobile devices 706, 707 that received an alert notification of the alert issued by mobile user (A) 701 are also shown. A software interface mechanism 708 may be used to merge the message interface feeds related to the alerts generated by mobile users (A) 701 and (B) 702. As discussed above, control display 700 may have features which operate similarly to the control display previously described in FIGS. 4-6.

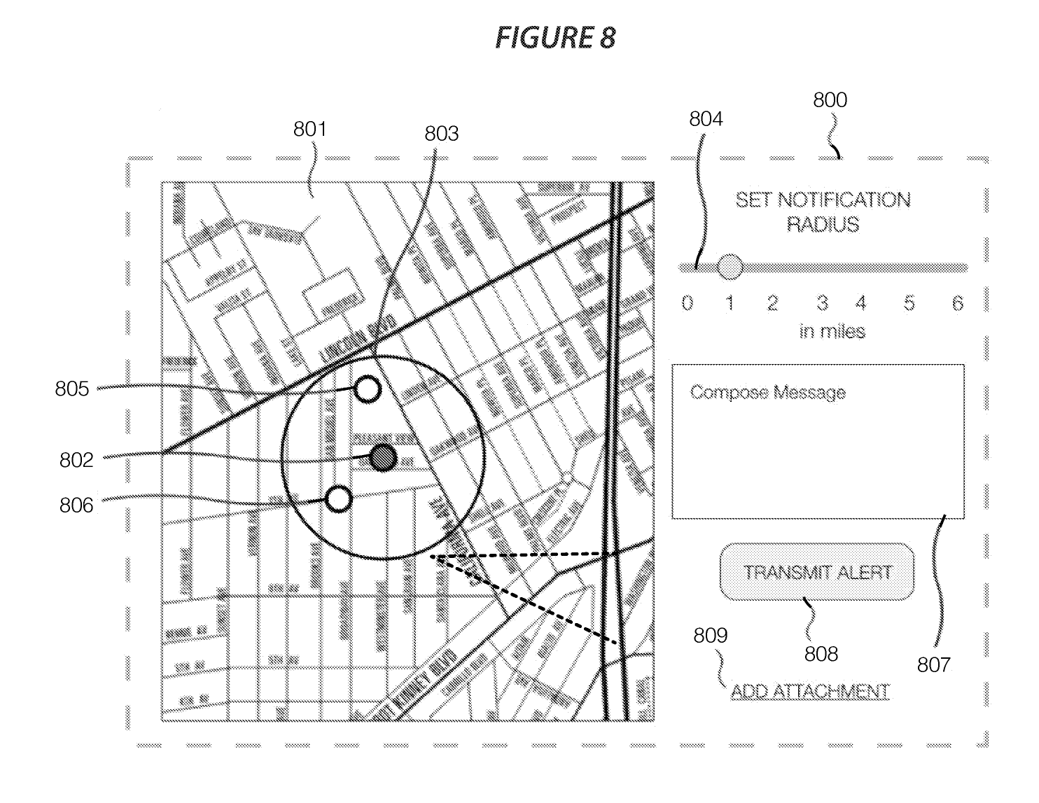

FIG. 8 is an illustration of a control display 800 of a public-service-agency user interface that enables a public service agency to create a global boundary around a location of an incident such that each mobile device within the global boundary is sent an alert or alert notification from a public agency. As shown, an adjustable geographic boundary 803 may be set (see geo-radius indicator 804) around a location of interest such as a scene of a crime, accident, or natural disaster such that crowd-sourced-user mobile devices and their subscribers may receive an alert or alert notification of the incident. In the example shown in the figure, the geographic boundary 803 is set to a one-mile radius surrounding the mobile device identified by icon 802.

In one implementation, icon 802 of map interface 801 may represent the location of a business-related incident. Public-safety-agency personnel may set a one-mile radius 803 around the business-related incident 802 such that nearby businesses, identified by icons 805 and 806 located within the geographic boundary 803, are sent notification alerts of the incident. For instance, if a bank is robbed, personnel at a public service agency may issue an alert to other nearby banks to prevent another bank robbery and possibly reprehend the assailant.

In yet another implementation, an emergency telephone call is made from a traditional LAN to a public safety dispatch center to report an incident which may be recorded in a public safety agency's computer aided dispatch system (CAD). While on scene, public safety responders may determine that the incident may effect an area 2-3 miles from the initial incident locus. Personnel having access to the public-safety-agency user interface may select a geographic boundary 803 surrounding the location of the incident and transmit an alert notification to mobile users on the mobile alert network within the selected geographic boundary. Furthermore, at the control display 800, a message may be composed 807 to transmit an alert 808 with the option to add an attachment 809 thereto.

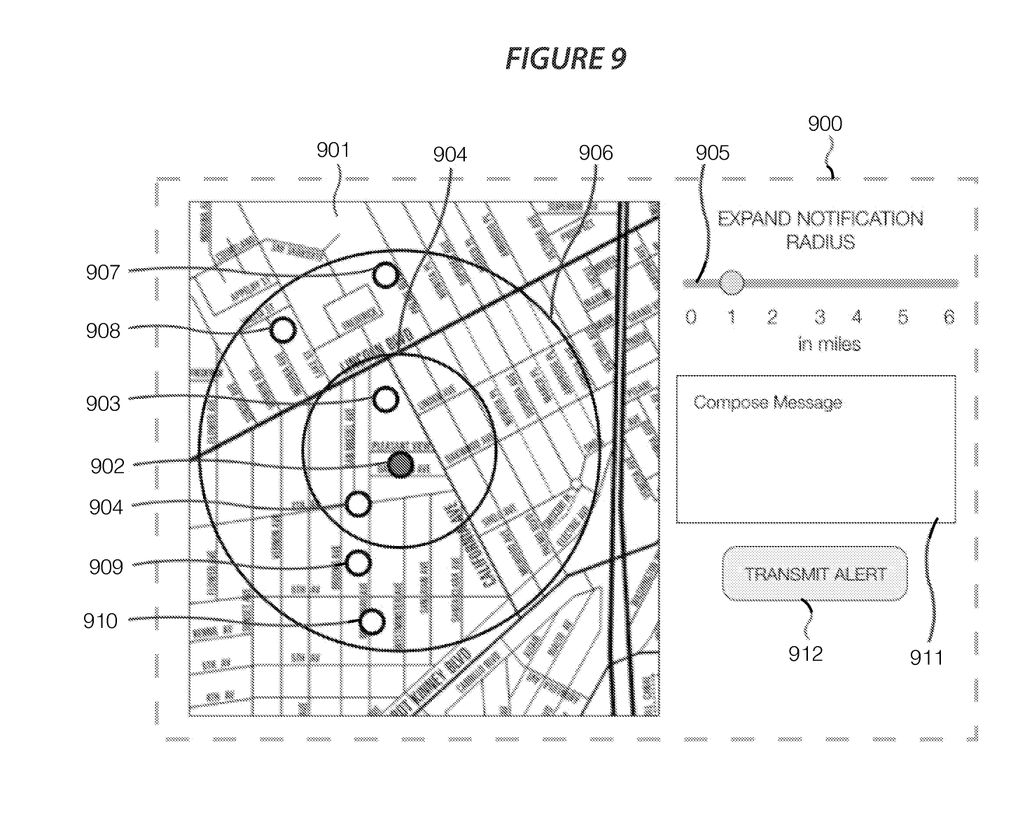

FIG. 9 is yet another illustration of a control display 900 of a public-service-agency user interface that enables a mobile user to change the global boundary. For instance, there may be times when public-safety-agency personnel desire to expand the geographic boundary around a location of interest 902 from a first setting 904 to a geographic boundary having a second setting 906 via a geo-radius indicator 905 such that more mobile devices on the mobile alert network may be made aware of an incident.

As shown, geographic boundary 904 enables alerts to be sent to mobile devices 903, 914. However, geographic boundary 906 enables alerts to be sent to mobile devices 903 and 914 in addition, to mobile devices 907-910 as shown by the icons of the mobile devices on the map interface 901. Accordingly, public-service agency personnel may compose 911 and transmit 912 messages and alerts throughout the mobile alert network according to a predefined proximity rule.

A user interface function 905 may be used to increase or decrease the geographic boundary 906 within select mobile user of the mobile alert network which receives notification and alerts. For example, the expanded geographic boundary 906 shows that mobile users indicated by icons 907-910 will also receive the re-transmitted alert notification. FIG. 9 also shows a user interface mechanism to compose 911 and transmit 912 a message that will be transmitted and re-transmitted upon an expansion of the geographic boundary 904.

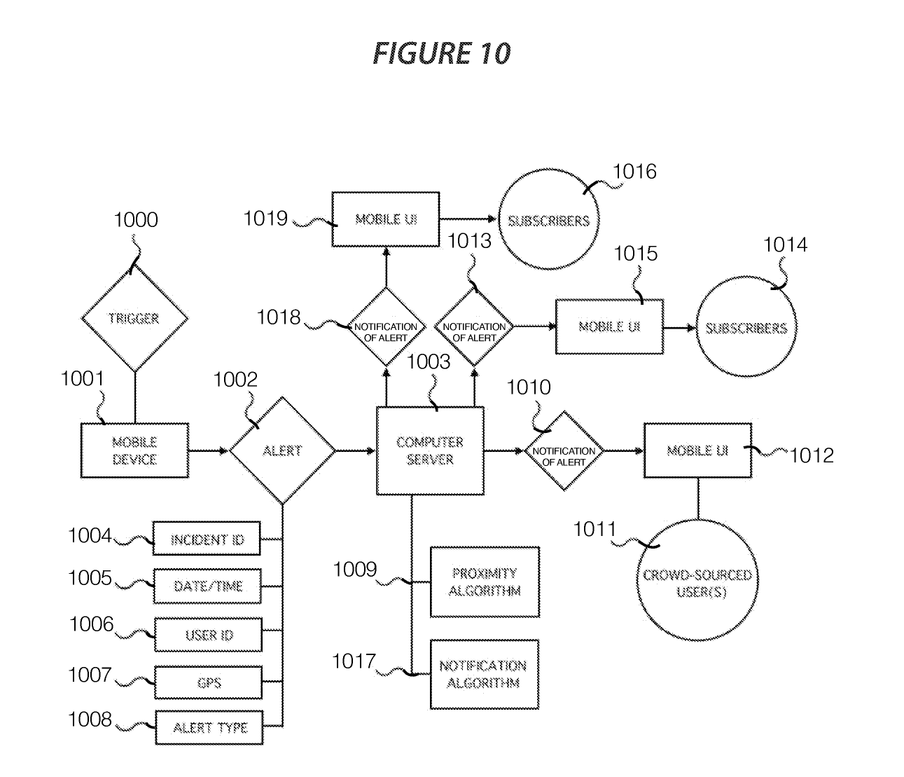

FIG. 10 is an exemplary layout illustrating a process of generating and transmitting alert notification(s) to crowd-sourced-user mobile devices and subscriber mobile devices. An alert may be generated when a mobile device 1001 places a call to emergency assistance (trigger 1001).

Alert data is also transmitted such as an unique incident number 1004, a time stamp 1005, a user ID 1006, GPS coordinates 1007 of the mobile device 1001, and the alert type 1008. Once an alert server(s) 1003 receives the alert(s) 1002, the alerts 1002 are processed and the alert server(s) 1003 uses the proximity algorithm 1009 to determine the location of other mobile devices on the mobile alert network that is in proximity to the location from which the alert 1002 originated.

In time, alert server(s) 1003 then wirelessly transmits “crowd-sourced” alert notification(s) to crowd-sourced users 1011 via software interface 1012. In addition, alert server(s) 1003 may also transmit alert notification 1013, 1018 to mobile subscribers 1014, 1016 via a mobile user interface 1015, 1019. Mobile subscribers 1014, 1016 may subscribe to various mobile devices on the mobile alert network.

Moreover, alert server(s) 1003 may use a notification algorithm 1017 to determine instances where a mobile user that receives a crowd-sourced alert requires that a notification alert 1018 be sent to a subscriber.

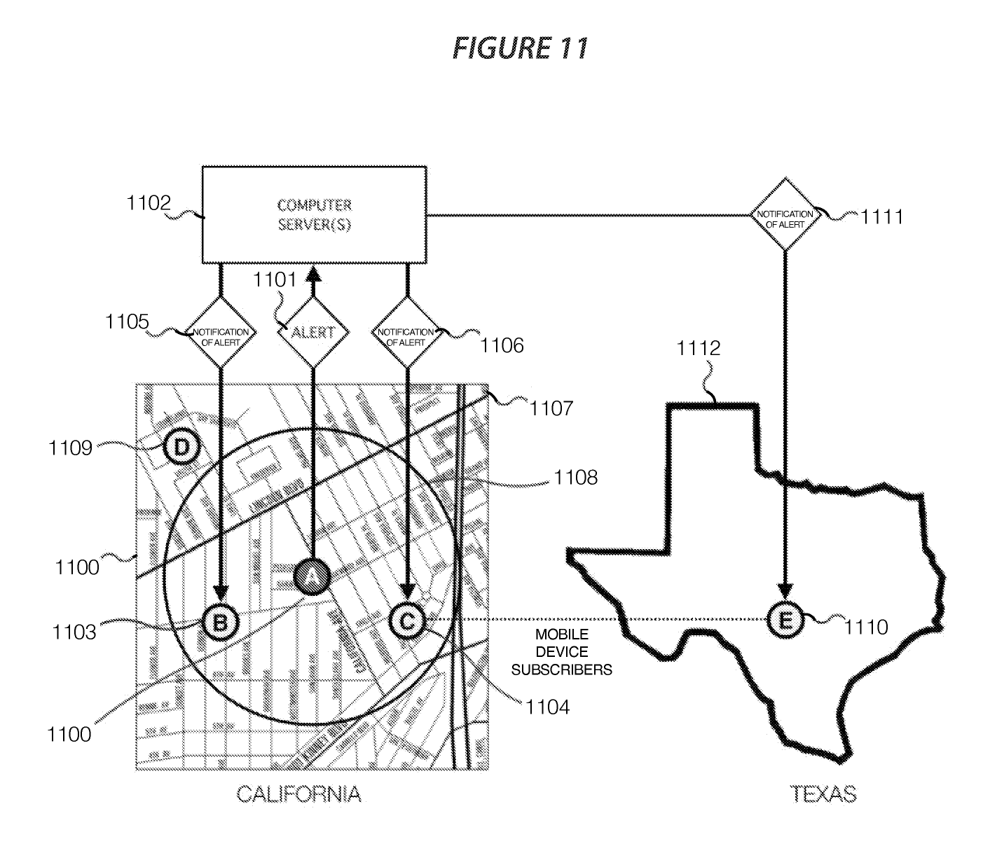

FIG. 11 is an illustration of a layout 1000 of the locations of a subscriber mobile device and crowd-sourced-user mobile devices in relation to a user mobile device that issued an alert. The embodiment shown illustrates icon A of an exemplary mobile device to transmit an alert 1101. Based on a proximity rule, alert server 1102 discovers the crowd-sourced-user mobile devices represented by icon 1103 (“User B”) and icon 1104 (“User C”) that are within the geographic boundary 1108 as displayed on the map interface 1107.

Accordingly, alert notifications 1105, 1106 are therefore transmitted to mobile users 1103, 1104, respectively. In this example, “Mobile user B” and “Mobile user C” have enabled the alert application settings to receive all crowd-sourced alert notifications within a one-mile geographic boundary 1108 of their current location. However, because “Mobile user D” 1109 is not within the one-mile geographic boundary 1108 of “Mobile user A,” “Mobile user D” does not receive a crowd-sourced alert notification.

Furthermore, map interface 1107 illustrates that “Mobile user C” 1104 is subscribed to by “Mobile user E” 1110. Therefore, according to one embodiment, “Mobile user E” has configured the settings of the alert application settings so that the mobile device receives an alert notification anytime “Mobile user C” 1104 receives a crowd-sourced alert notification (or transmits an alert). The mobile subscriber settings may be stored on the alert server(s) 1102 such that when “Mobile user C” receives a crowd-sourced alert 1106, an alert notification alert 1111 informing “Mobile user E” that “Mobile user C” has received a crowd-sourced alert notification is transmitted to the alert servers 1102. For the purpose of this example, “Mobile user E” receives the crowd-sourced alert notification in the State of Texas 1112 based on the alert notification 1106 received by “Mobile user C.”

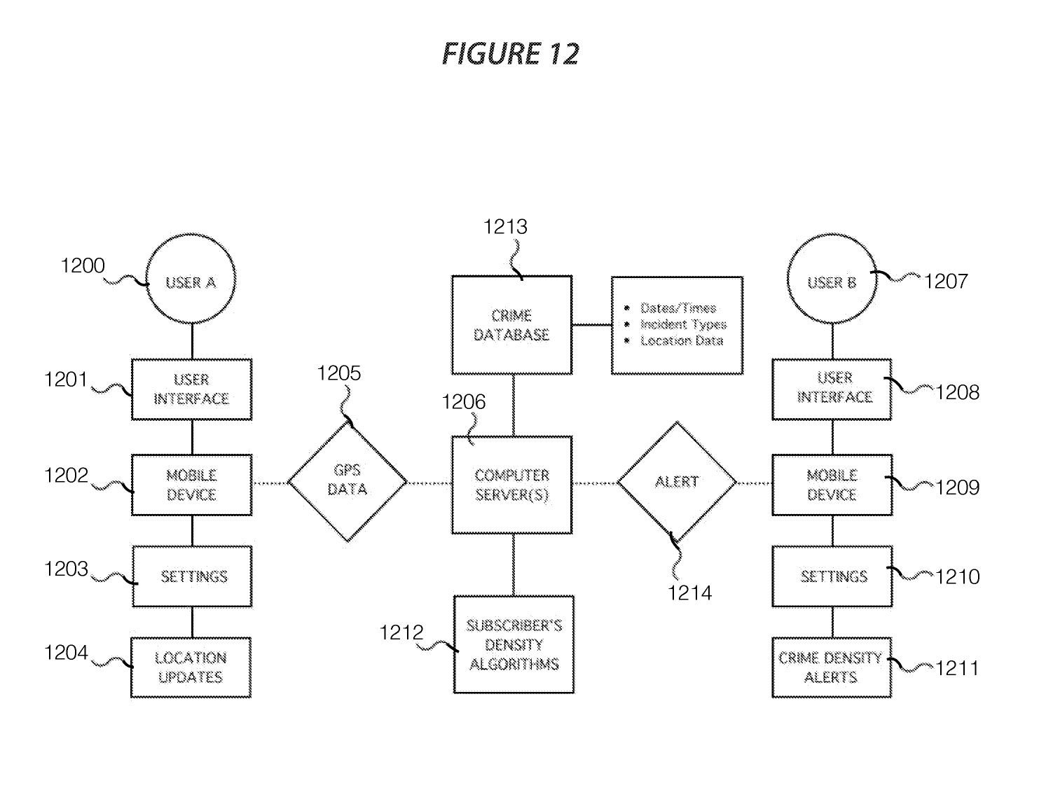

FIG. 12 is an illustration of an exemplary process for generating alerts to subscriber mobile devices when a user mobile device arrives at a location where the aggregate number of crime incidents within a predetermined time period exceeds a threshold value. In some implementations, “Mobile user A” 1200 uses the user interface 1201 to configure the alert application settings 1203 to transmit periodic location data 1204 (settings that determine time between updates) using GPS functions installed on the user's mobile device 1202 such that GPS location data 1205 is set to the alert server(s) 1206. In some embodiments, alert server(s) 1206 has, or is coupled to, a crime database 1213 which includes date, time, incident types, and location data of recorded crime events.

Advantageously, “Mobile user B” 1207 may use user interface 1208 to configure alert application software settings 1210 of mobile device 1209 to receive crime density alerts 1211 based on “Mobile user B's” 1207 location. In some embodiments, the settings 1210 are transmitted to alert server(s) 1206. Furthermore, when “Mobile user A's” GPS location 1205 is transmitted to the alert server(s) 1206, an algorithm 1212 determines whether the threshold (based on settings 1210) set by “Mobile user B” 1207 has been met or exceeded. In the event that the threshold is met or exceeded, the alert server(s) 1206 will transmit an alert notification 1214 to “Mobile user B” 1207. Accordingly, the present disclosure affords the capability for mobile devices within the mobile alert network to subscribe to various user mobile devices and set unique threshold settings for each mobile device subscribed thereto.

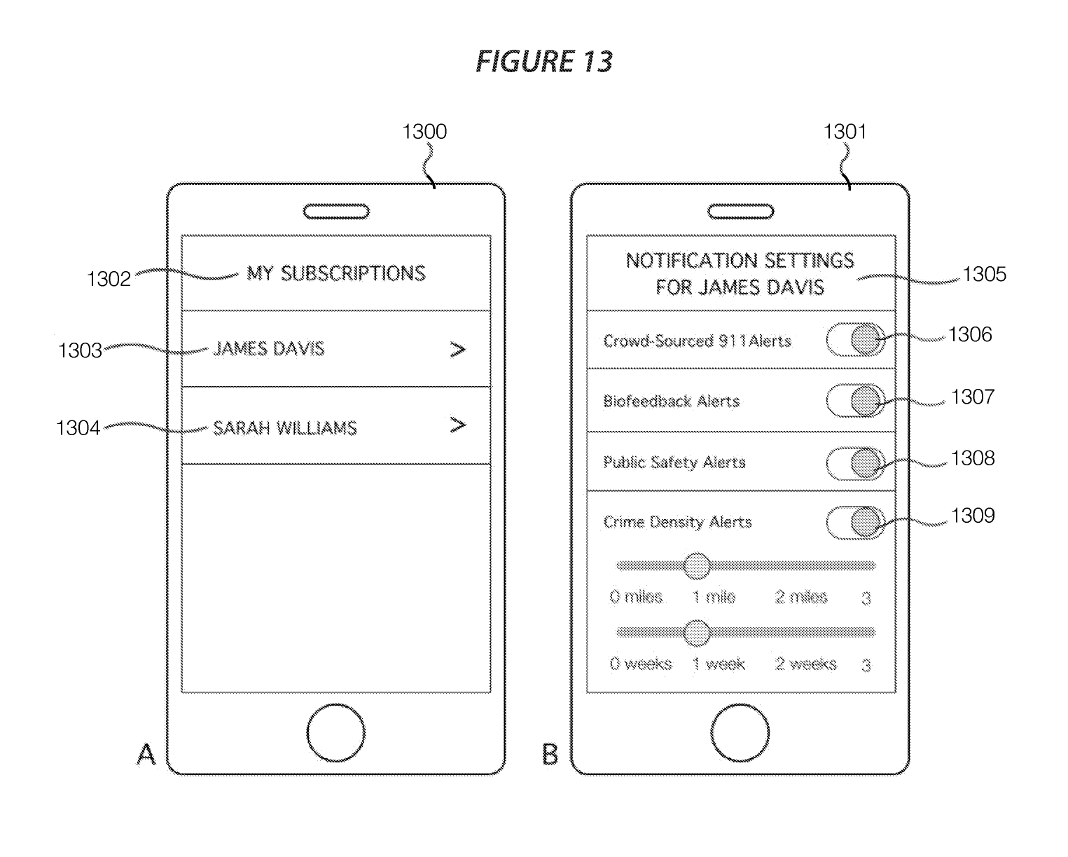

FIG. 13 is an exemplary illustration of two mobile device display screenshots 1300, 1301 (i.e., screenshots A, B) showing a list 1302 of subscriber user mobile devices along with the type of notifications to be received by a subscribed mobile device. As shown, screenshot “A” features a list of user mobile devices subscribed to by the mobile user and user interface mechanisms to configure the type of alerts to be received for each subscribed mobile device 1303, 1304.

For example, screenshot “B” shows notification setting options 1305 for crowd-sourced 9-1-1 alerts 1306, biofeedback alerts 1307, public-safety alerts 1308, and crime-density alerts 1309 for each subscribed mobile device 1305 (e.g., James Davis).

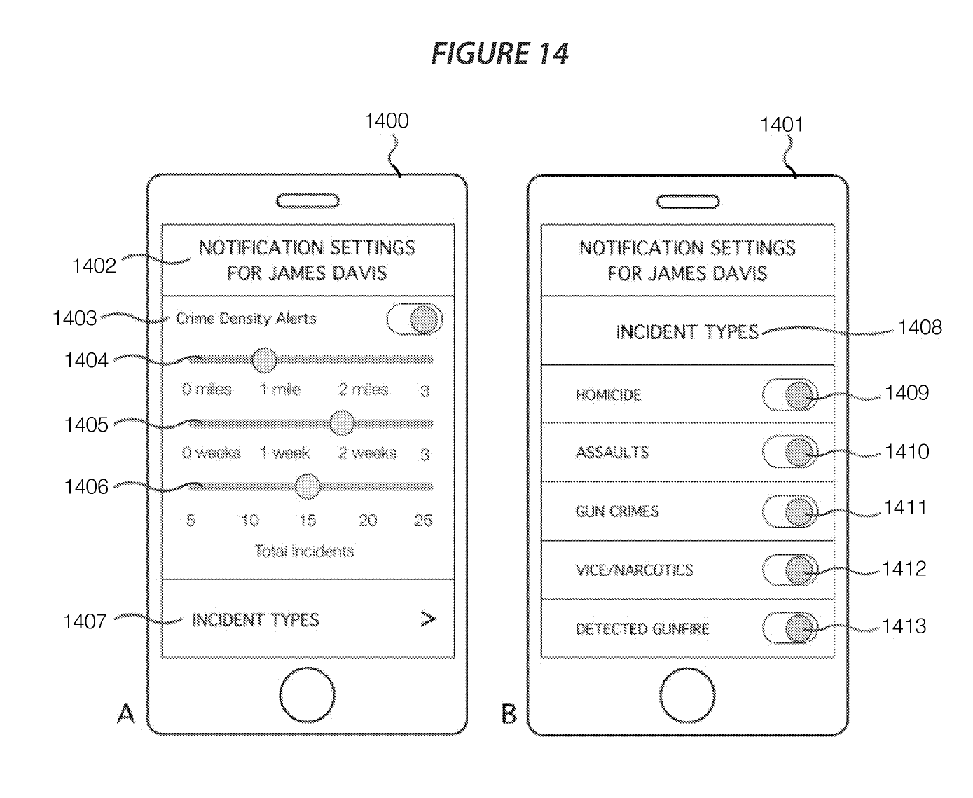

FIG. 14 is an exemplary illustration of two mobile display screenshots 1400, 1401 (i.e., screenshots A, B) that illustrates notification settings 1403 and incident type settings 1408 for a subscriber mobile device. For the purpose of the embodiment shown, crime density alerts for James Davis may be enabled or disabled (1403) when the subscribed user mobile device transmits its GPS location to the alert server(s) on the mobile alert network. The subscriber mobile user may configure the notification settings to receive alerts based on a configured geographic boundary 1404 (e.g., 0-3 miles), timeframe 1405 (e.g., 0-3 weeks), and incident threshold 1406 (e.g., 5-25 incidents).

A user mobile device may also “drill down” to specific types of incidents (e.g., criminal incidents) via user interface function 1407. For instance, screenshot “B” shows a list 1409-1413 of criminal incident types 1408 that may be enabled by the subscriber user to generate the crime density alerts.

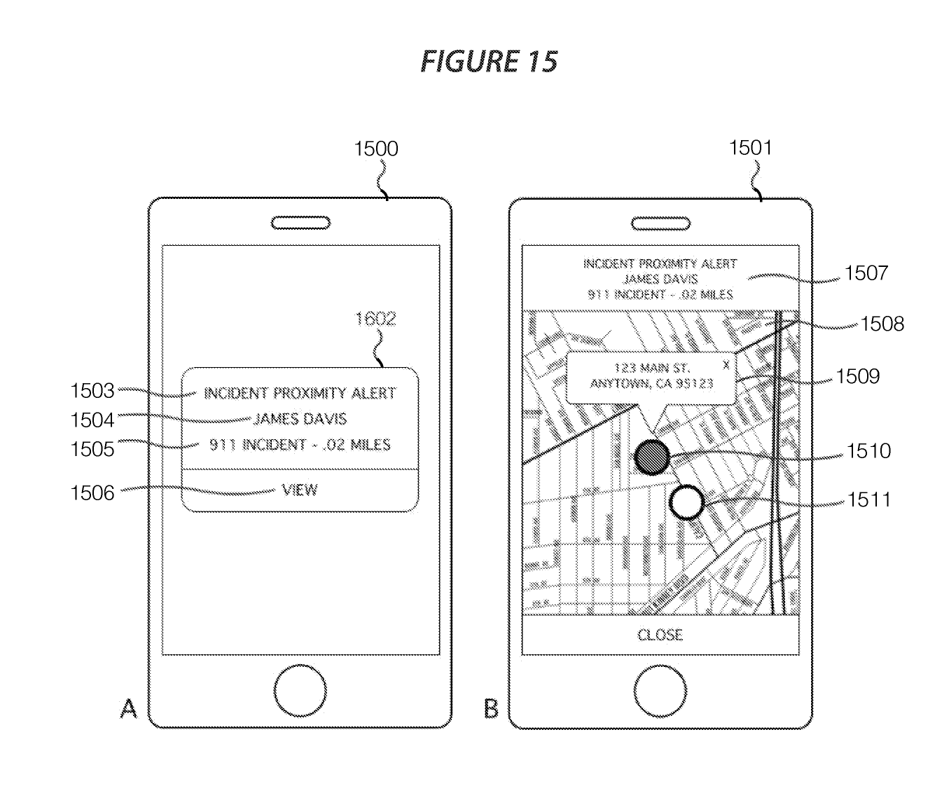

FIG. 15 is an exemplary illustration of two mobile display screenshots 1500, 1501 (i.e., screenshots A, B) showing an alert notification received by a crowd-sourced-user mobile device. Screenshot “A” shows an incident proximity alert 1502 received by a crowd-sourced-mobile user. As shown, the alert notification 1502 displays the alert type 1503, the name/ID 1504 of the owner of the mobile device that transmitted the alert, any additional information related to the alert 1505, and the distance from the incident (e.g., 0.2 miles).

The crowd-sourced-mobile user may select the “View” function 1506 to receive more information about the incident. For example, “screenshot “B” 1501 displays a mobile interface 1508 with the address 1509 of the incident (or location of mobile device when alert was transmitted) along with icons 1510, 1511 showing the locations of the devices in relation to each other. In this view, information of the incident proximity alert (e.g., crowd-sourced-user name, incident type, etc.) may be displayed.

Screenshot “B” shows an example of an incident proximity alert 1507, displayed on a map interface 1508 which displays location information (GPS and/or street address) 1509, the location of the user mobile device responsible for generating the alert 1510, and the location of the subscribing mobile device users 1511.

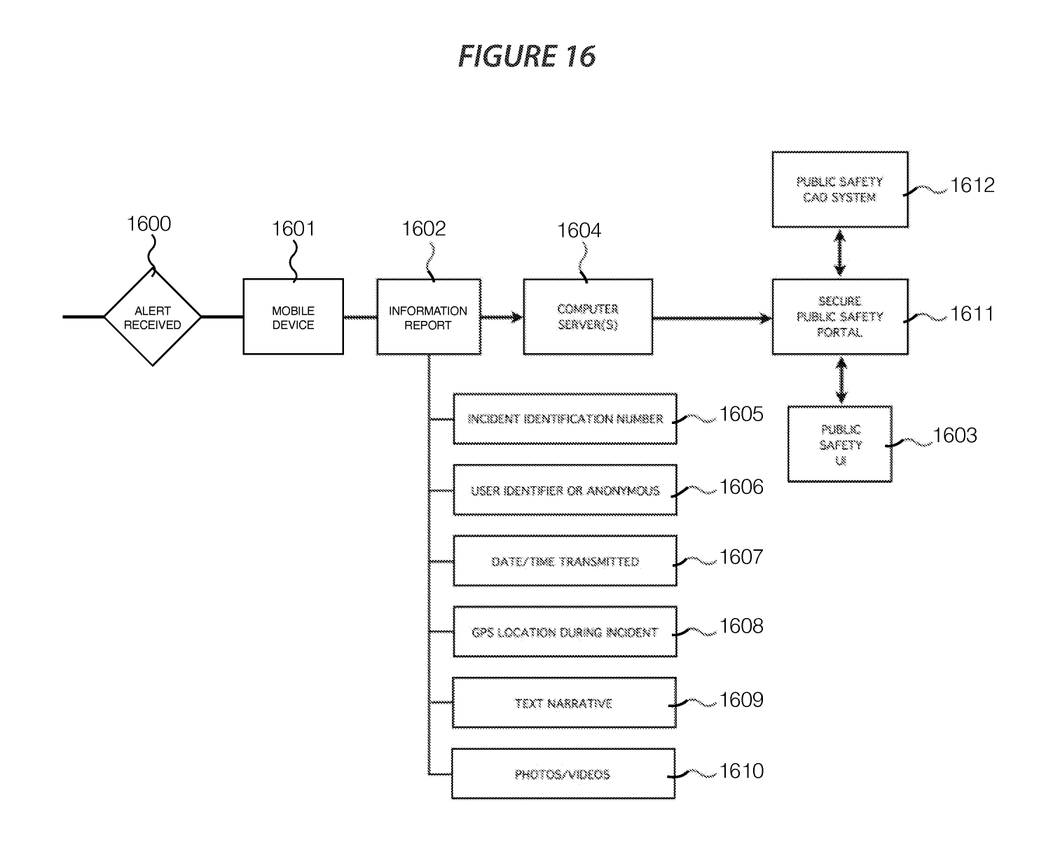

FIG. 16 is an exemplary layout of a process for receiving a notification of an alert at a user mobile device and in response sending an information report to alert server(s) and public safety systems on the mobile alert network. As shown, an alert notification 1600 is received by a mobile device 1601 indicating that another mobile device on the network has dialed an emergency number. Mobile device 1601 may be configured to transmit an information report 1602 to the alert servers 1604 when the mobile user of the mobile device 1601 elects to transmit relevant information to the mobile alert network.

Information report 1602 may transmit useful information such as, but not limited to, an incident ID number 1605, a user identifier 1606 (or anonymous), a timestamp of the transmission 1607, the GPS location of the mobile user transmitting the report at the time the notification alert was received as well as the GPS location 1608 of mobile device 1601, text narrative(s) information 1609, and digital photographs or videos 1610.

In some embodiments, data from the information reports 1602 may be accessed by public safety personnel via a public-safety user interface 1603 (or public safety CAD system 1612) via a secure public safety portal 1611.

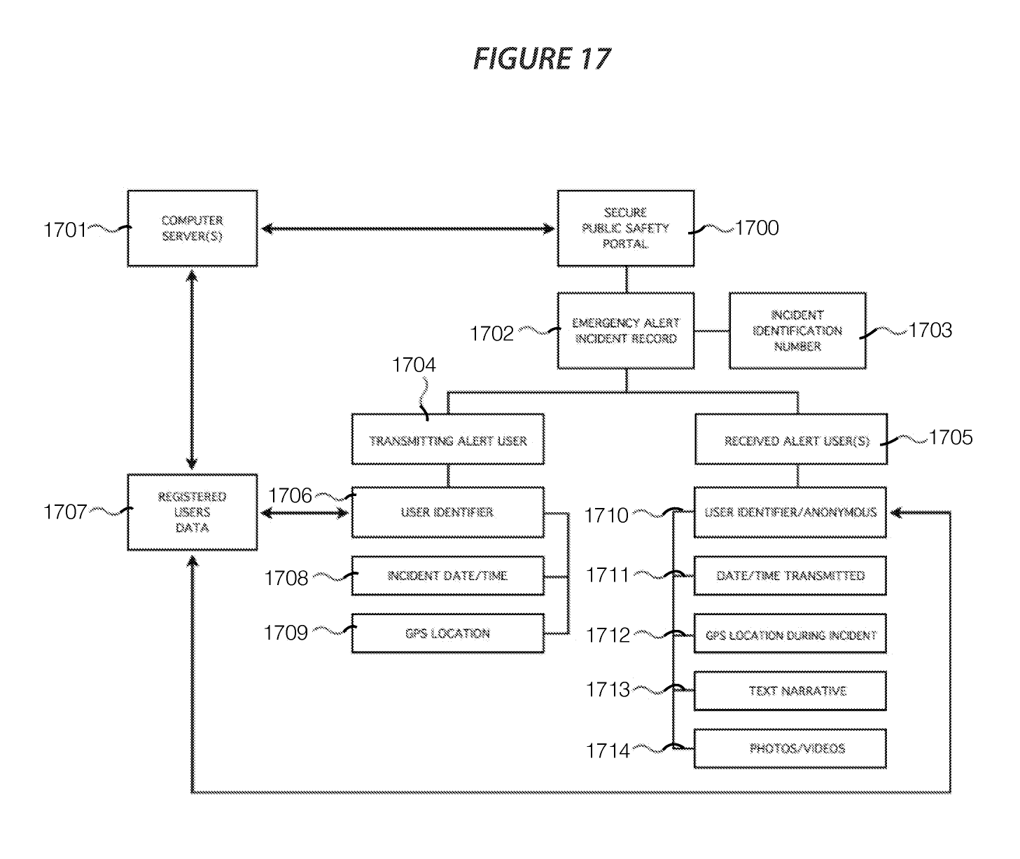

FIG. 17 is an illustration of an exemplary layout showing the distribution of user data throughout a network/system consistent with the present disclosure. As shown, alert data transmitted from a mobile device within the mobile alert network may have associated metadata that is transmitted with the alert. For example, when an alert is transmitted from a mobile device (i.e., transmitting alert user 1704), a user identifier 1706, incident date/time 1708, and GPS location of the mobile device that sent the data is transmitted along with the alert data.

Once the alert is transmitted, it is received at alert server(s) 1701 where the alert is processed (to determine register user data 1707) to send alert data to other mobile device and system components of the mobile alert network. In some embodiments, the alert data or alert notification is forwarded to secure public safety portal 1700 where an emergency alert incident record is prepared.

In response to a received alert notification, data from an emergency alert incident record 1702 (having an incident identification number 1703) may be accessible to a secure public safety portal 1700. Such data may include information identifying the mobile user or an anonymous designation 1710, the timestamp 1711 that the information report was transmitted 1711, the GPS location 1712 of the user mobile device that transmitted the alert, text narrative data 1713, and digital photographs and/or videos 1714.

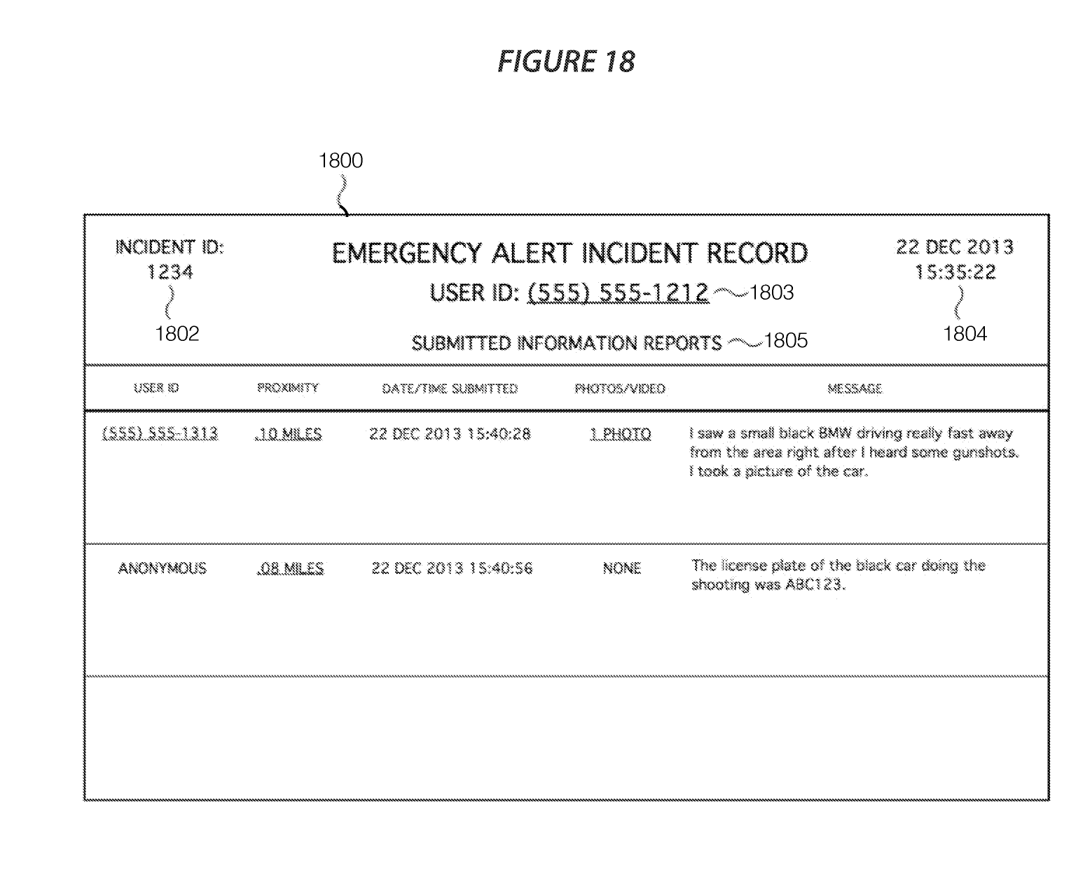

FIG. 18 is an exemplary illustration of an emergency alert incident record 1800 generated when a user mobile device contacts emergency assistance. As shown, an emergency alert incident record 1800 may include an incident ID 1802, a user ID 1803 (e.g., mobile phone number), and the timestamp 1804 when the emergency alert incident record was generated. Most notably, the emergency alert incident record lists information from two incident reports 1805.

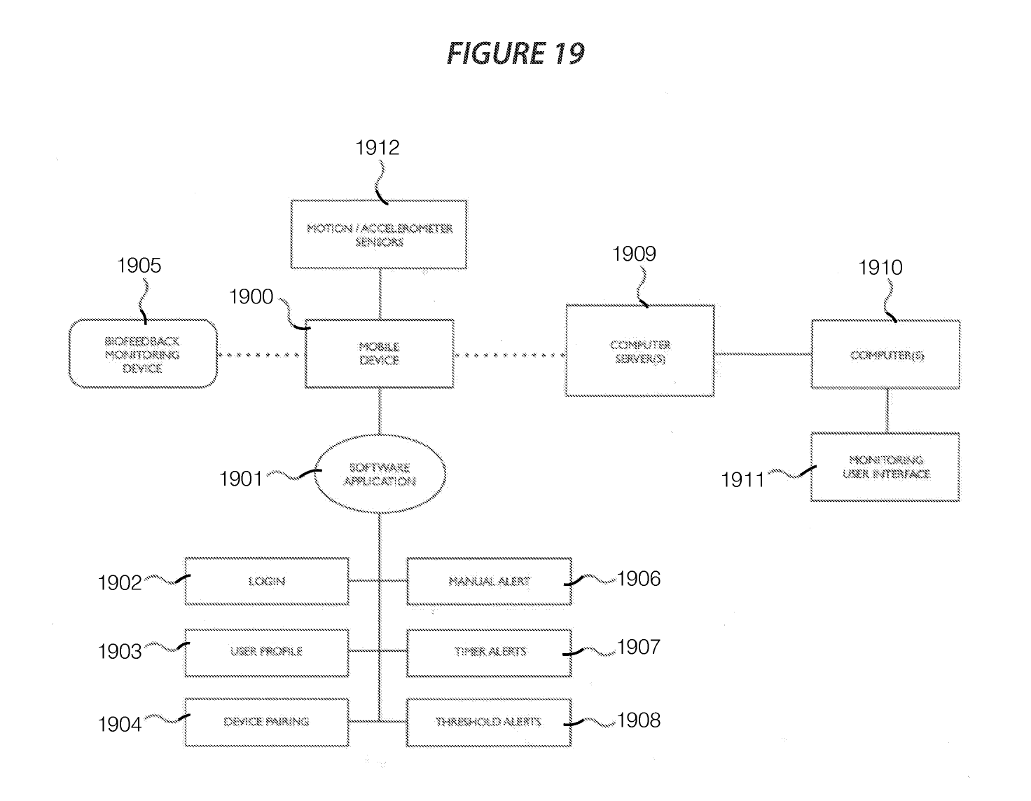

FIG. 19 is an exemplary layout of several software and hardware components which incorporate biofeedback monitoring in accordance with systems and methods. A mobile device 1900 having an alert application 1901 installed thereon enables mobile users to log into the system using an authentication process 1902, generate or modify a user profile 1903, sync/pair 1904 the mobile device 1900 with a biofeedback-monitoring device 1905, manually transmit an alert 1906, configure timer alert 1907, and configure biofeedback-threshold alerts 1908.

Mobile devices 1900 may transmit data and alerts to alert server(s) 1909, which in turn, may transmit alert notifications to computers 1910 accessible to monitoring center personnel via a monitoring user interface 1911. In this embodiment, mobile device 1900 has components 1912 capable to detect a falling motion. For instance, exemplary components may include, but are not limited to, accelerometers, gyroscopes, and timers to detect movement.

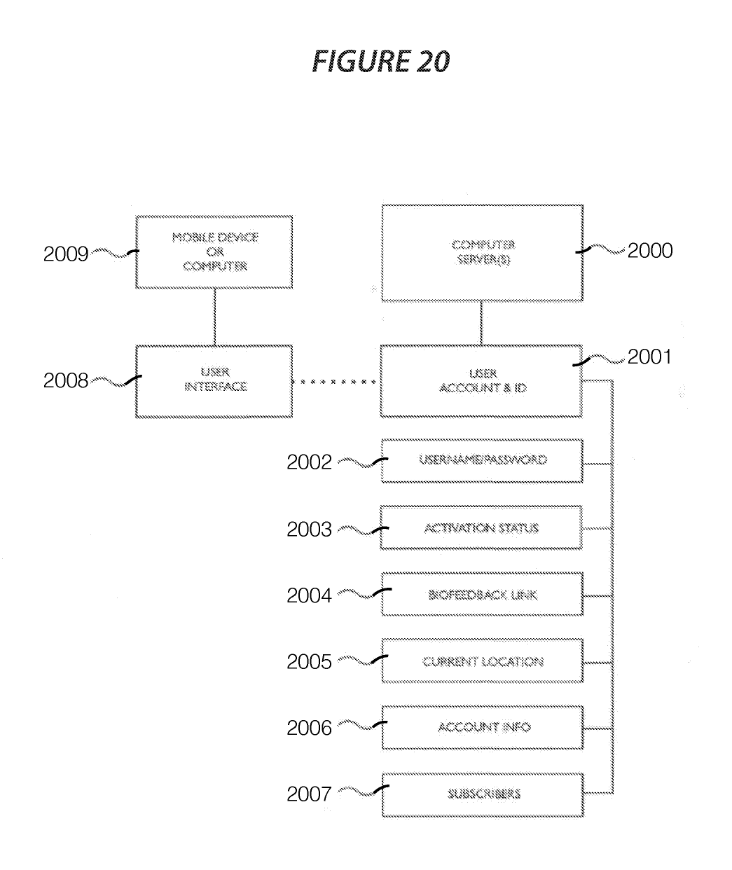

FIG. 20 is an exemplary illustration that shows the configuration of user account data. Alert server(s) 2000 may maintain user account ID 2001 that includes a username and password 2002, an activation status of a mobile user (on/off) 2003, biofeedback link 2004, the current location 2005 of the mobile device 2009, user account information 2006, and the subscribers 2007 of the user mobile device for each mobile device on the mobile alert network.

In addition, alert server(s) 2000 may also include personal information of the mobile device users such as the mobile user's name, date of birth, physical description, medical conditions, home and work addresses, description of vehicles owned, known threats, and restraining order and account information 2006 if applicable. Alert server(s) 2000 may also maintain the email addresses and SMS numbers of subscribers 2007 that the mobile user wishes to notify in the event of an emergency. As such, the mobile device mobile user may elect to have alerts, alert notifications, and messages sent to mobile devices of family and friends, with their consent, that are on the mobile alert network. Advantageously, the account data may be linked to a mobile device and may be accessed using an interface 2008 from the linked mobile device or a computer 2009.

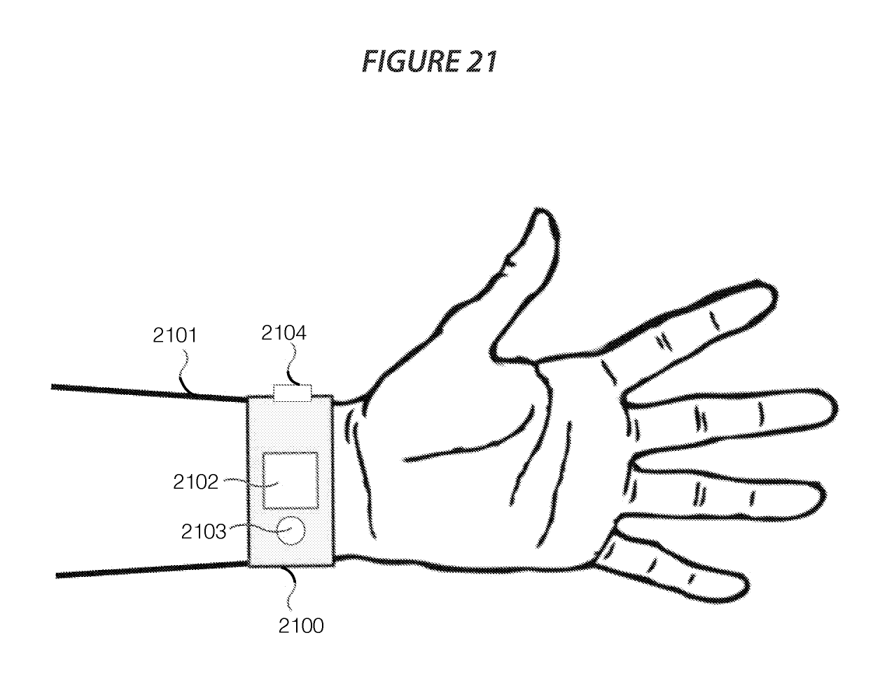

FIG. 21 is an illustration of an exemplary biofeedback-monitoring device consistent with systems and methods of the present disclosure worn on a user's wrist 2101. In an embodiment, the device's sensors 2102 wirelessly transmit monitored biometric data to the user's mobile device (not shown) using any of several wireless techniques (e.g., Bluetooth technology, Near Field Communications, etc.). Biofeedback-monitoring device 2100 may include other button(s) 2103, 2104 to carryout additional functionality.

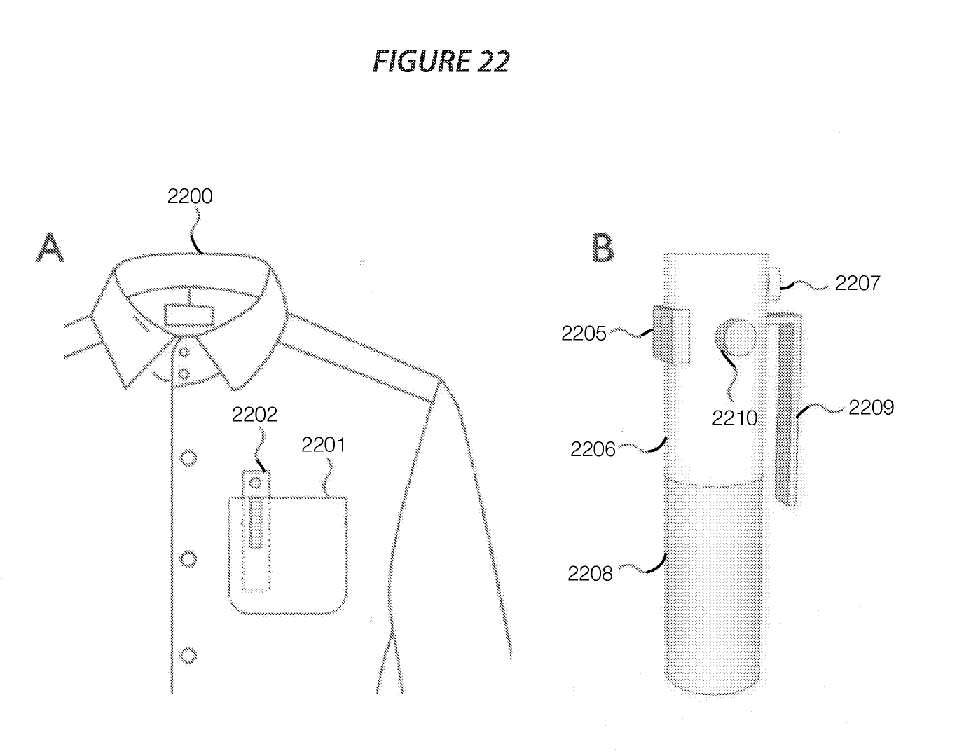

FIG. 22 is another illustration of an exemplary biofeedback monitoring device 2202. Illustration “A” shows the shirt pocket 2201 of the shirt 2200 containing an inserted biofeedback-monitoring device 2202 whereas Illustration “B” shows a larger view of the biofeedback-monitoring device 2202. In addition, the biofeedback-monitoring device 2202 includes capability to wirelessly connect with a mobile device on the mobile alert network allowing the reception and transmission of audio over a cellular network, capability to measure biofeedback data such as electro-cardio and pulse data, galvanic skin response data, and electro-muscular data.

Furthermore, biofeedback-monitoring device 2202 may wirelessly transmit biofeedback data to a linked mobile device, a camera capable of transmitting video through a linked mobile device to alert server(s), a rechargeable power supply 2208, and a clipping mechanism 2209 to fasten the biofeedback-monitoring device to an article of clothing. In addition, button or switch 2207, that when manipulated by the mobile user, causes a manual alert to be transmitted to the mobile alert network. Biofeedback-monitoring device 2202 may include other button(s) 2205, 2210 disposed on the body 2206 of the device 2202 to carryout additional functionality.

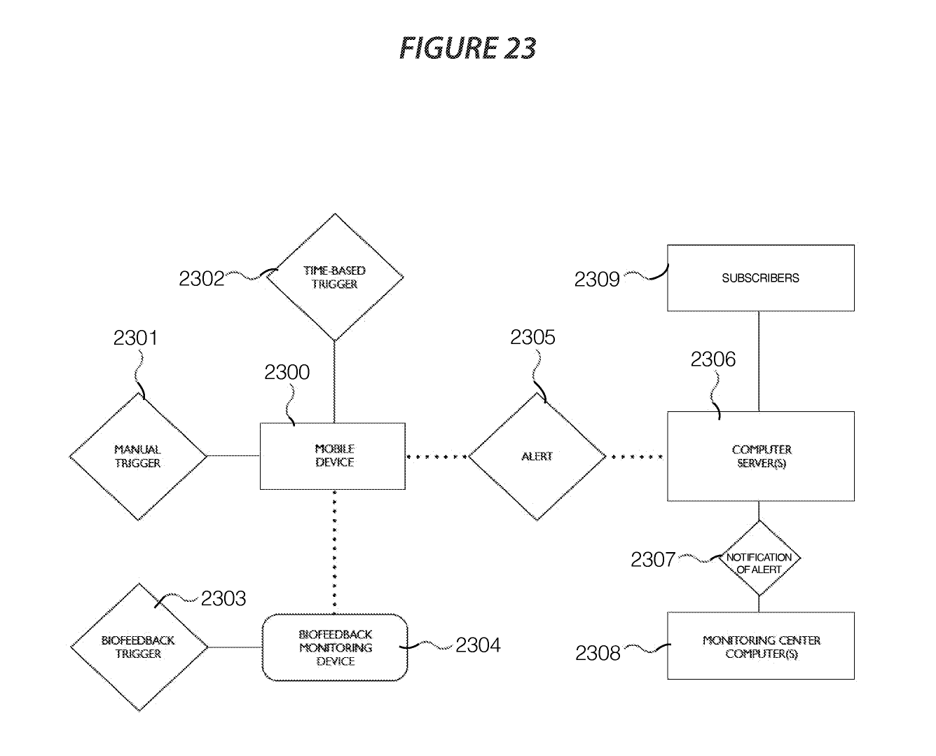

FIG. 23 is an exemplary layout illustrating various alert options in accordance with systems and methods of the present disclosure. As shown, user mobile device(s) may transmit an alert based on a manual trigger 2301, timer-based trigger 2302, or biofeedback trigger 2303. For example, an alert 2305 may be generated when a biofeedback-monitoring device 2304, linked to the mobile user's mobile device 2300, receives data that meets or exceeds a predetermined biofeedback-response threshold associated with the biofeedback trigger 2303.

In some embodiments, when the alert(s) 2305 is transmitted to the computer server(s) 2306, an alert notification 2307 is then transmitted to monitoring center computer(s) 2308 to be evaluated by monitoring center personnel and/or subscribers 2309. Likewise, an alert may be generated and transmitted from mobile device 2300 manually (i.e., manual trigger 2301) or based on a predetermined time limit or event (i.e., timer-based trigger 2302).

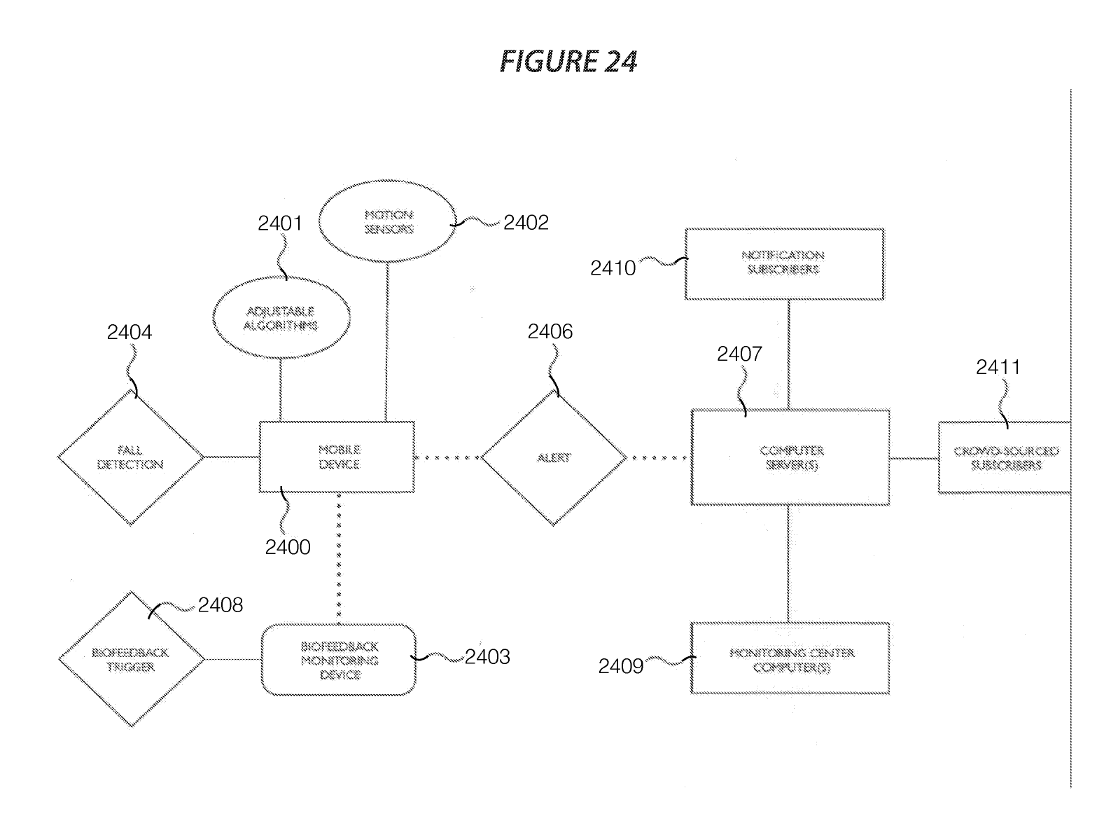

FIG. 24 is an exemplary layout illustrating the process of fall detection and an alert-generated response from a user mobile device in accordance with systems and methods of the present disclosure. Mobile device 2400 is capable of analyzing biofeedback back sent from a biofeedback-monitoring device 2403 based on a set of predefined rules 2401. The mobile device 2400 also has motion sensors 2402 (and/or accelerometers) to detect when the mobile device 2400 is moving.

In particular, the mobile device 2400 may detect when the mobile device 2400 is in a fall state 2404. In some embodiments, when mobile device 2400 detects when mobile device 2400 is in a fall state, the device 2400 transmits an alert 2406. User mobile device 2400 may also generate alerts based on a biofeedback trigger 2408 as described above. Once the alert 2406 is received and processed by the alert servers 2407, alert notification(s) may be transmitted to monitoring center(s) 2409, subscriber mobile devices 2410, and crowd-sourced-user mobile device(s) 2411.

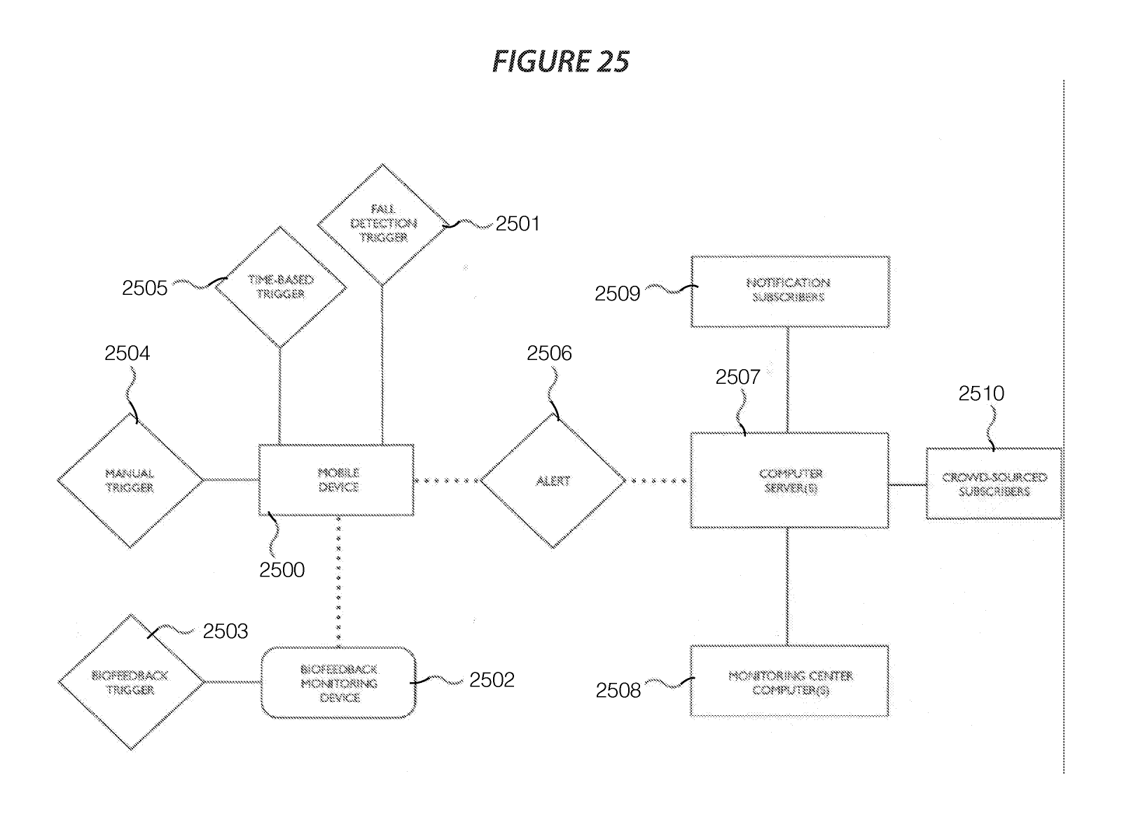

FIG. 25 is an exemplary layout illustrating the process of generating various types of alerts (e.g., based on fall detection 2501, biofeedback trigger 2503, manual trigger 2504, and timers 2505). Accordingly, a mobile device 2500 having an alert system application of the present disclosure installed thereon may generate alerts for various incident triggers. For example, mobile device 2500 may be wirelessly linked to a biofeedback monitoring device 2502 which includes a biofeedback trigger 2503 such that mobile device 2500 generates alerts based on physiological responses which meet or exceed a predetermined threshold value of biofeedback trigger 2503. Moreover, in the event that biofeedback trigger 2503 detects that the mobile user's physiological responses exceed a predetermined threshold, the mobile user may be alerted that via a message displayed on the display screen of the mobile device 2500 that an alert 2506 is to be generated unless aborted by the mobile user by submitting a password within a predetermined timeframe. After the alert 2506 is generated, the alert is received at the server 2507 and may be forwarded in whole or in part (and may be formatted) to monitoring center computer(s) 2508, notification subscribers 2509, and crowd-sourced subscribers 2510.

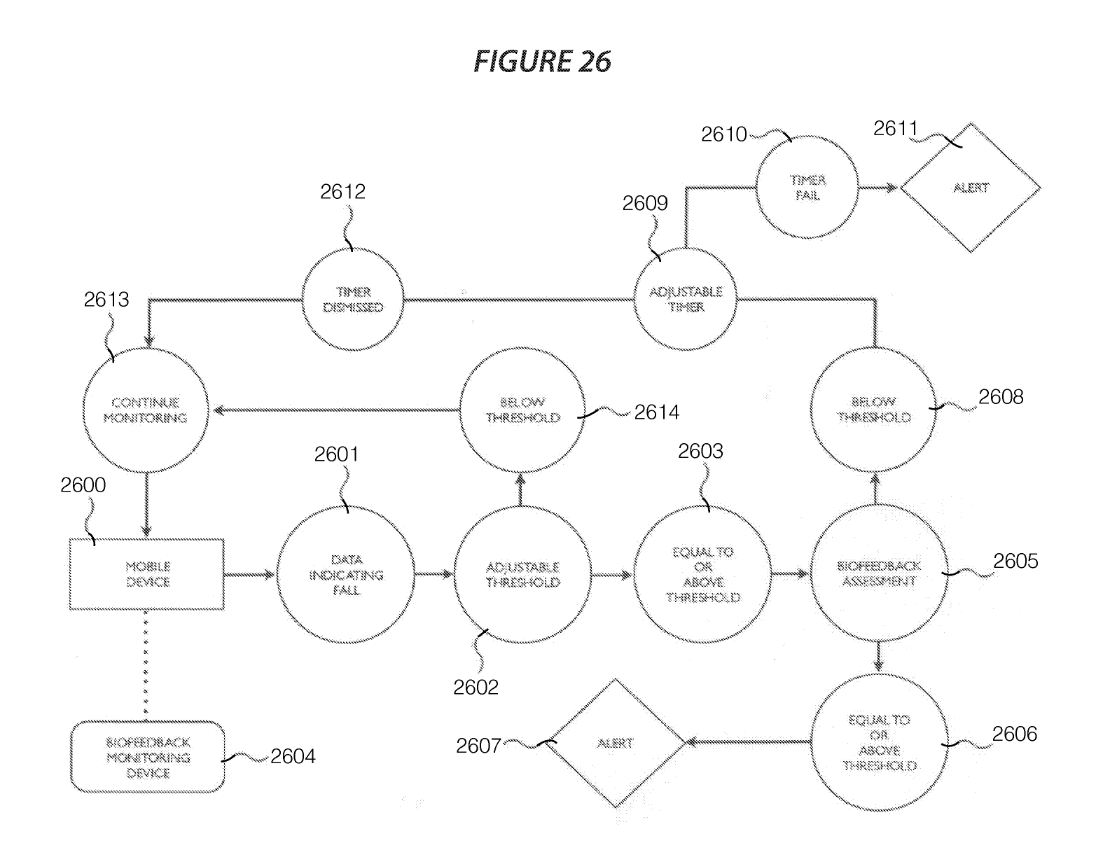

FIG. 26 is an exemplary layout illustrating a process of fall detection using a biofeedback-monitoring device(s) 2604 coupled to a mobile device 2600 consistent with the present disclosure installed thereon. More specifically, mobile device 2600 is capable of detecting movement consistent with a fall 2601.

If data 2601 is below configurable threshold 2614, the biofeedback-monitoring device continues monitoring. However, when data (e.g., acceleration, time, etc.) consistent with a fall is equal to or greater 2603 than a configurable threshold value 2602, the biofeedback-monitoring device 2604 will perform a biofeedback assessment 2605. In some embodiments, the biofeedback assessment 2605 validates the occurrence of a detected fall. In particular, the mobile user's physiological responses, electro-cardio data, pulse data, galvanic-skin response data, electro-muscular data, pupil-dilation data, or eyelid-blink data may be measured by the biofeedback-monitoring device 2604.

If the physiological data assessed is equal to or exceeds 2606 the threshold(s) for each respective physiological target, an alert 2607 is transmitted to alert server(s) on the mobile alert network. Alternatively, if the physiological data accessed is below threshold 2608, a configurable timer 2609 begins. In some embodiments, if the mobile user fails to enter a correct passcode (e.g., PIN) within a predetermined timeframe 2610, an alert 2611 is transmitted. However, if the physiological data is submitted in time, the timer is dismissed 2612 and the biofeedback-monitoring device 2604 continues monitoring 2613.

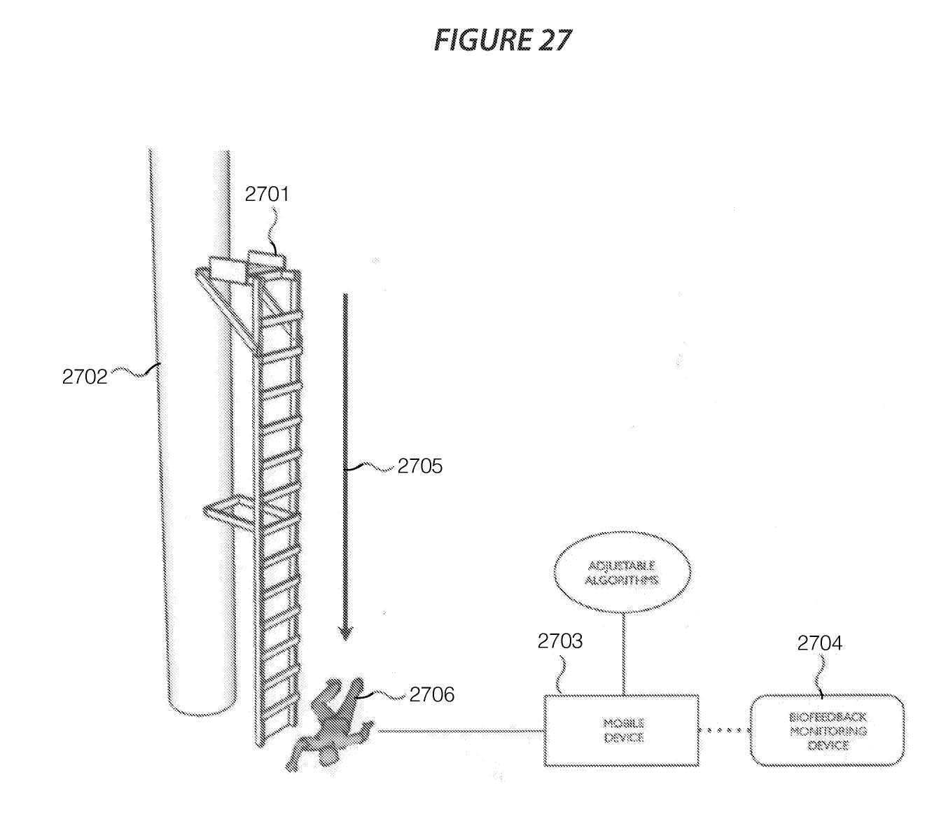

FIG. 27 is an illustration of a mobile user 2706 equipped with a user mobile device 2703 having biofeedback-monitoring and fall-detection capability consistent with systems and methods of the present disclosure. In this example, the user's mobile device 2703 having a biofeedback monitor device 2704 coupled thereto may detect the mobile user's fall 2705 from a hunting apparatus 2701 according to the functionality of alert application installed, previously described, installed within the mobile device 2703.

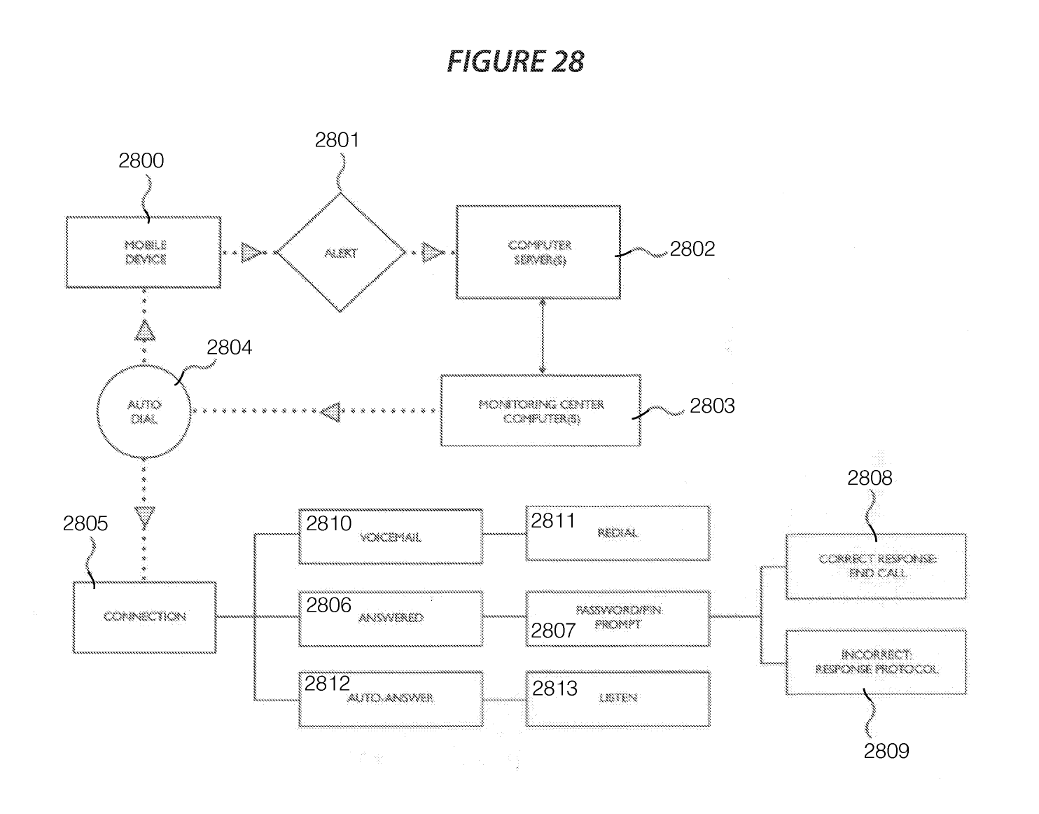

FIG. 28 is an exemplary layout of various functions to be performed in response to an incoming alert. When a configured mobile device 2800 transmits an alert 2801 to alert servers 2802, an alert notification is transmitted to monitoring center computer(s) 2803. The alert server(s) 2802 may automatically dial 2804 the telephone number of the mobile device transmitting the alert to connect the mobile user associated with the alert to monitoring center personnel 2803. If a connection 2805 is made, monitoring center personnel are able to verbally communicate 2806 with the mobile user, and personnel may request that the mobile user render a predetermined verbal password 2807. If the mobile user provides the correct password, the alert notification incident ends 2808. Alternatively, if the mobile user does not provide the correct password/PIN or no response is given 2809, a notification may be transmitted to enforcement personnel.

If the automated call results in voice mail activation 2810, the alert server(s) 2802 will terminate the call and automatically redial 2811, the mobile user's telephone number, in an attempt to connect with the mobile user to determine the mobile user's safety. The mobile alert network installed on a mobile device 2800 may also force the mobile device 2800 to answer after a predetermined number of rings 2812. If this feature is enabled, the user mobile device 2800 will automatically connect and provide monitoring center personnel with the ability to monitor (“listen) 2813 audio transmissions by the mobile user's phone in an attempt to determine the mobile user's safety.

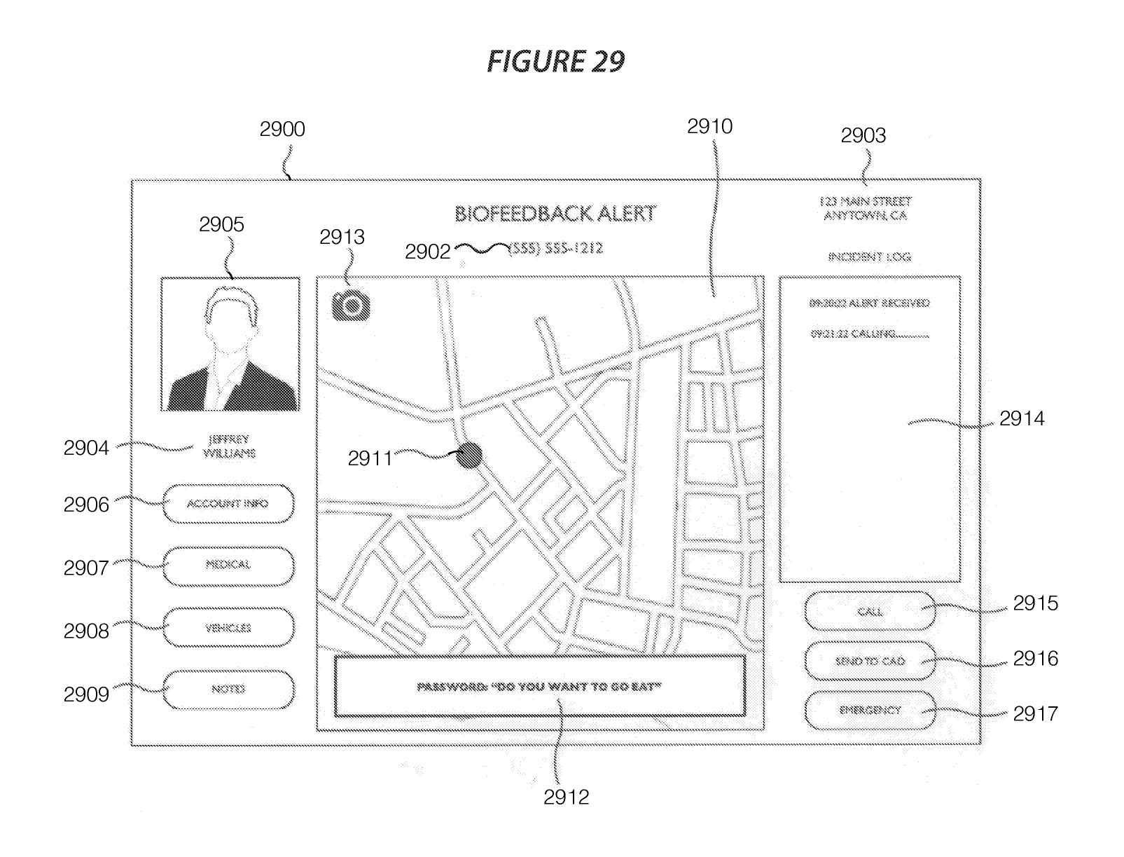

FIG. 29 is an exemplary illustration of a mobile-device-alert display 2900 that may be used to evaluate and respond to alerts. The display 2900 features a visual representation of the type of alert received (e.g., biofeedback alert), the telephone number 2902 of the mobile device that generated the alert, and the location of the mobile device when the alert 2903 was generated.

The display 2900 also shows the name 2904, a photograph 2905 of the mobile user 2905, and provides a means to view additional data such as the mobile user's account information 2906 (e.g., date of birth, physical description, associated addresses), medical conditions 2907, description of vehicles 2908, notes 2909, and any other relevant information that may assist in an emergency situation. Furthermore, the display 2900 features a map of the mobile user's current location 2910 and an icon representing the specific location of the mobile user 2911.

A password 2912 associated with the mobile user account 2912 and provides a mechanism to view or listen to video and audio transmitted by the mobile user if such a configuration has been enabled 2913. Also shown is a real-time activity log 2914 of events related to the incident that is accessible from a monitoring center. Personnel may make a call 2915, send alerts or messages to a CAD system 2916, or contact emergency assistance 2917.

A telephone call may be made to the appropriate public safety agency's emergency dispatch center, utilizing geo-location data generated by the mobile user's current or last known location and determining from stored database information, the correct public safety agency with jurisdiction to contact via telephone. Additionally, if connection has been made with a mobile user in response to an alert, and it is determined by monitoring center personnel that local public safety personnel should respond, a three-way call among monitoring center personnel, the mobile user's mobile cellular device, and public safety personnel may be enabled 2917.

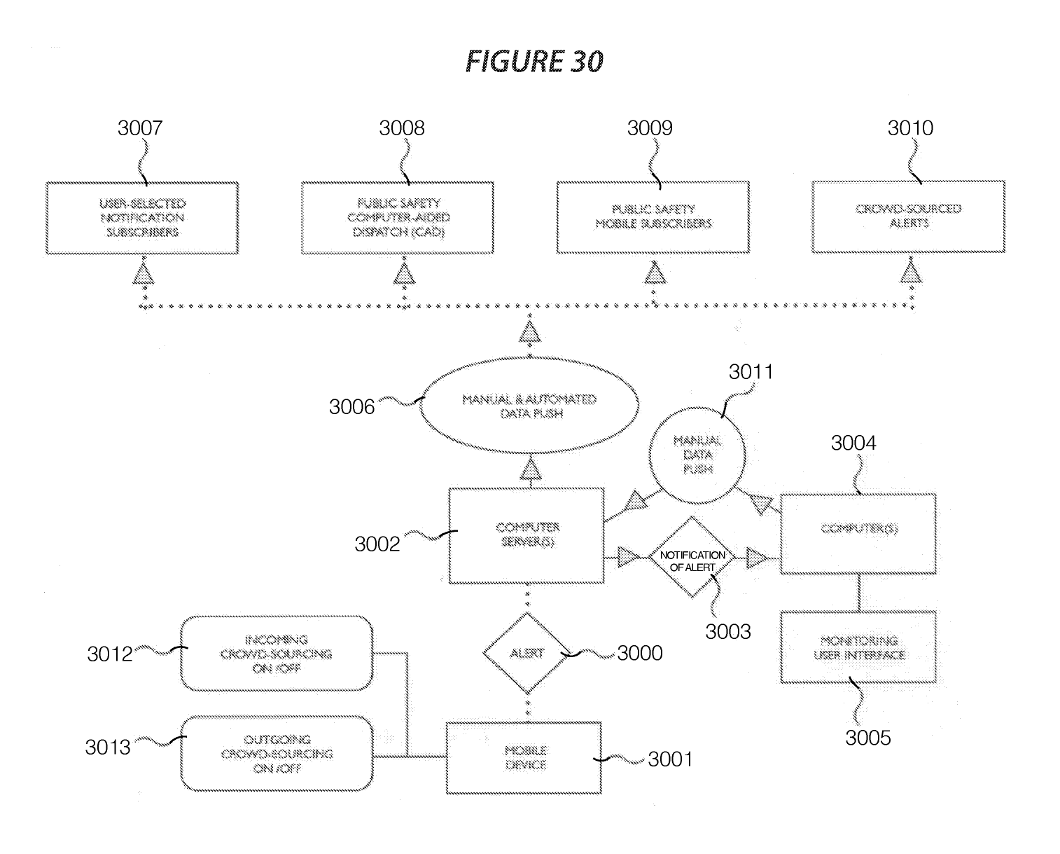

FIG. 30 is an exemplary layout of several software and hardware components and various manners to generate alerts within a mobile alert network. Alerts 3000 are transmitted from a user mobile device 3001 to alert servers 3002 and subsequently distributed alerts to various systems. In some embodiments, after the alert server(s) 3002 processes the alert, the alert server(s) 3002 forwards an alert notification 3003 to a monitoring center computer system 3004. Personnel at the monitoring center may access the computing system 3004 via a monitoring interface 3005. Moreover, personnel at a monitoring center may direct the alert notifications to be forwarded to other computing systems and devices within the mobile alert network (e.g., subscriber mobile devices 3007, public-safety computer-aided dispatch (CAD) 3008, public-safety mobile subscribers 3009, and crowd-sourced-user mobile devices 3010).

The system settings of the alert application have been configured to automatically transmit data concerning the received alert to other devices within the mobile alert network automatically to user-selected notification subscribers 3007, public safety computer aided dispatch systems 3008, and public safety mobile subscribers 3009. In addition, personnel at a monitoring center may use a computer interface 3005 to manually transmit alert notifications and messages to computers and mobile devices configured to receive these messages. Further shown in FIG. 30, is the ability of monitoring center personnel to utilize a computer interface 3005 to manually cause the transmission of received alert notification data to locations (computers and/or mobile devices) where a software mechanism has been implemented to enable the reception of alert notification data transmitted by the disclosure. Advantageously, a user mobile device 3001 may elect to enable or disable 3012, 3013 the incoming and outgoing crowd-sourcing function of the device 3001.

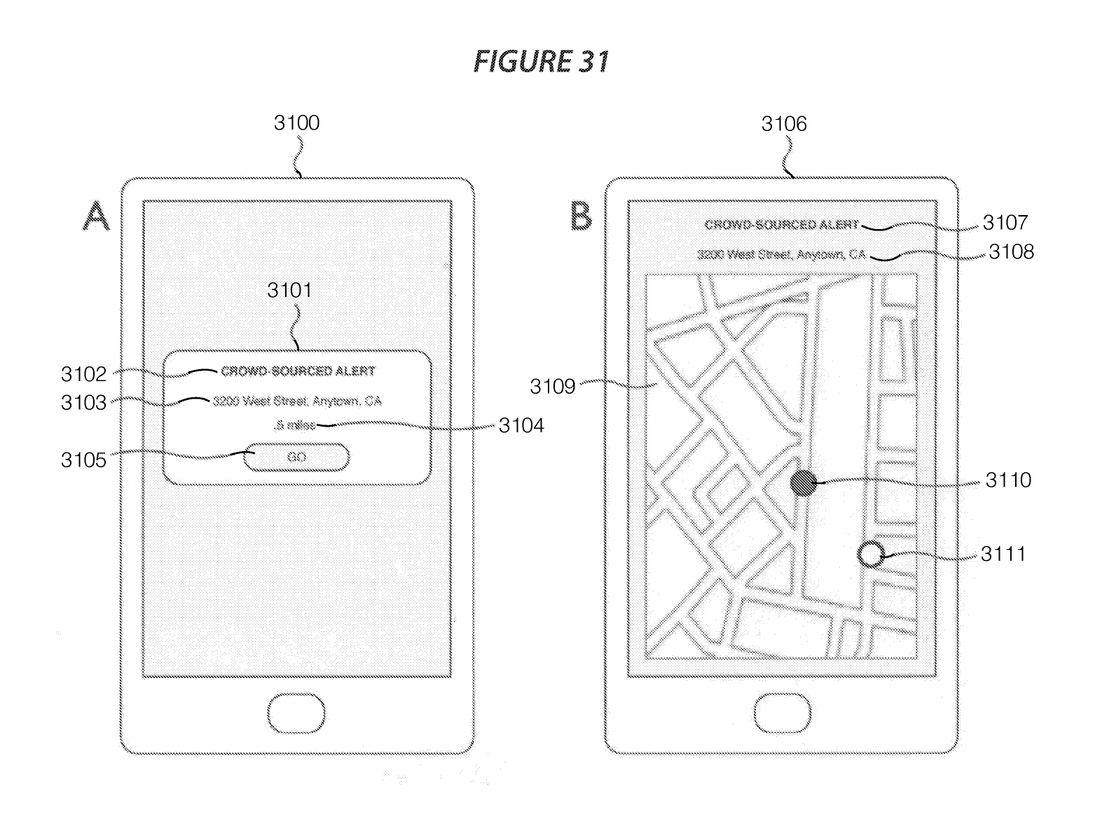

FIG. 31 is an exemplary illustration of two mobile device screenshots 3100, 3106 (i.e., screenshots A, B) that may be used to evaluate and respond to alerts in accordance with systems and methods of the present disclosure. Illustration “A” provides a screenshot of a display 3100 featuring a crowd-sourced alert 3101 which displays the address 3103 of the user mobile device which generated the alert 3102 and the distance 3104 that the mobile device of the current mobile user is located from the user mobile device which generated the alert 3102. To view more information about the alert, the “Go” function 3105 may be selected by a mobile user.

Illustration “B” provides a screenshot of a display 3106 featuring a map display 3109 upon which displays a crowd-sourced alert indicator 3107 with the address 3108 of the incident (or the address of the mobile user that generated the alert. In addition, the map display includes location icons 3110 and 3111 of the crowd-sourced-user mobile device and the user mobile device.

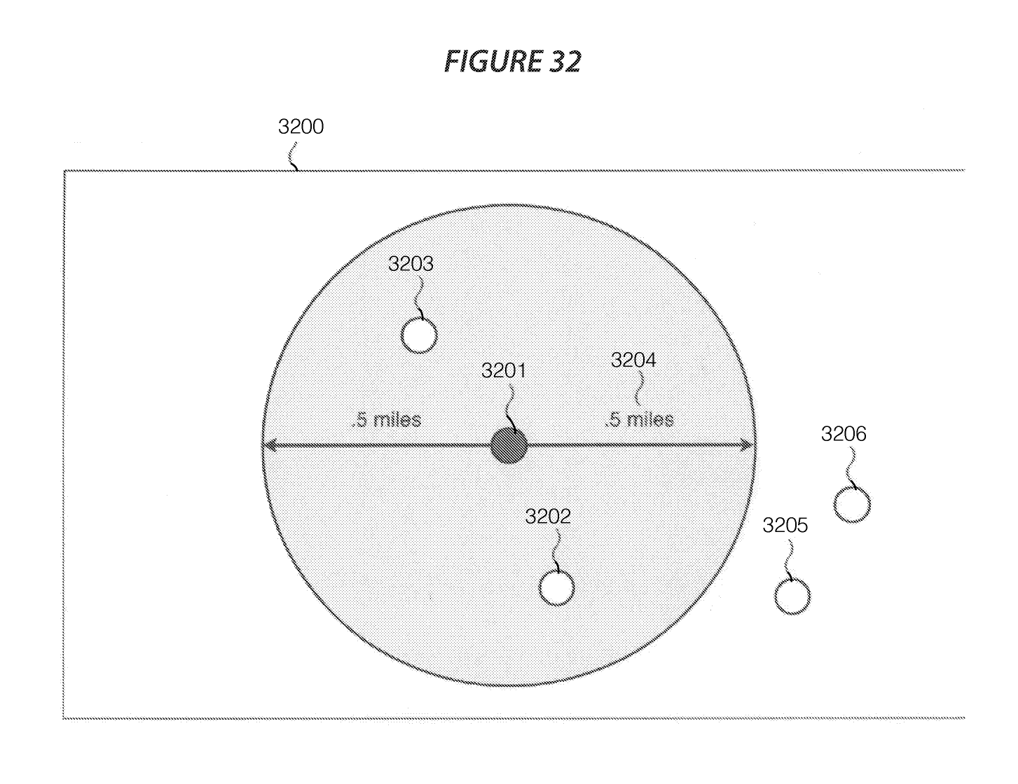

FIG. 32 is an illustration of a geographic boundary 3200 around a user mobile device and other mobile devices in relation to crowd-sourced-user mobile devices within a mobile alert network. As shown, user mobile device icon 3201 has configured system settings to receive crowd-sourced alerts from other devices (e.g., 3202, 3203) within the mobile alert network that are within a 0.5 mile geographic boundary 3204. In contrast, because user mobile devices 3205 and 3206 are outside of the 0.5 mile geographic boundary 3200, user mobile device 3201 would not receive crowd-sourced alerts from these devices.

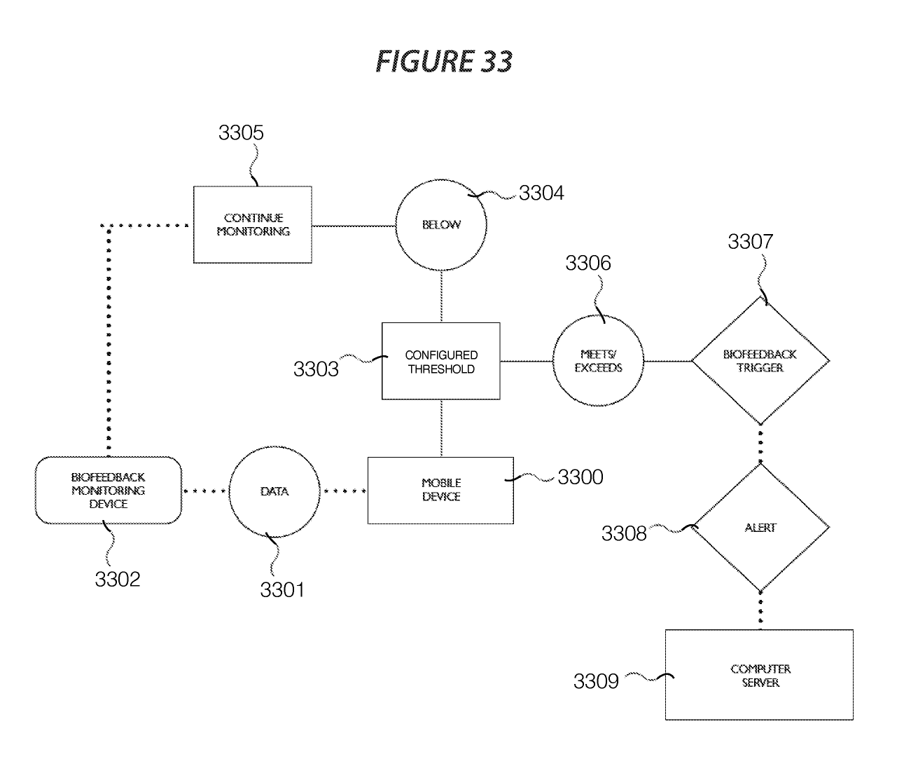

FIG. 33 is exemplary layout illustrating an alert process when a biofeedback monitoring device 3302 generates an alert. In the embodiment shown, mobile device 3300 may wirelessly receive data 3301 from biofeedback monitoring device 3302. In some embodiments, the alert application within the mobile device 3300 includes configurable threshold(s) for one or several biometric parameters measured by the biofeedback monitoring device 3302.

In particular, the alert application may be configured to receive data from the biofeedback monitoring device 3302 which may meet or exceed 3306 the configured threshold 3303 thereby triggering 3307 an alert 3308. Once mobile device 3300 generates an alert 3308, the alert 3308 is transmitted to alert server(s) 3309.

For example, data 3301 may indicate that the mobile device moves in a direction consistent with a fall a distance that is equal to or greater than a configurable threshold value 3303. In some embodiments, if the calculated distance of movement consistent with a fall is equal to or greater than the data threshold value 3303, a configurable will begin counting down and a user interface prompt will be displayed on the user mobile device that requires a personal identification number (PIN) to be dismissed by server 3309.

If the mobile user fails to enter the correct PIN before the timer expires, an alert will be transmitted. If the mobile user correctly enters the required PIN before the timer expires, an alert will not be transmitted and will continue to process and analyze the data.

In the event that data indicating the mobile device is moving in a direction consistent with a fall 3301, and the data receives indicates that the distance of the fall was below 3304 than the threshold currently configured, an alert will not be transmitted and the disclosure's monitoring components will continue 3305 to process and analyze the received data.

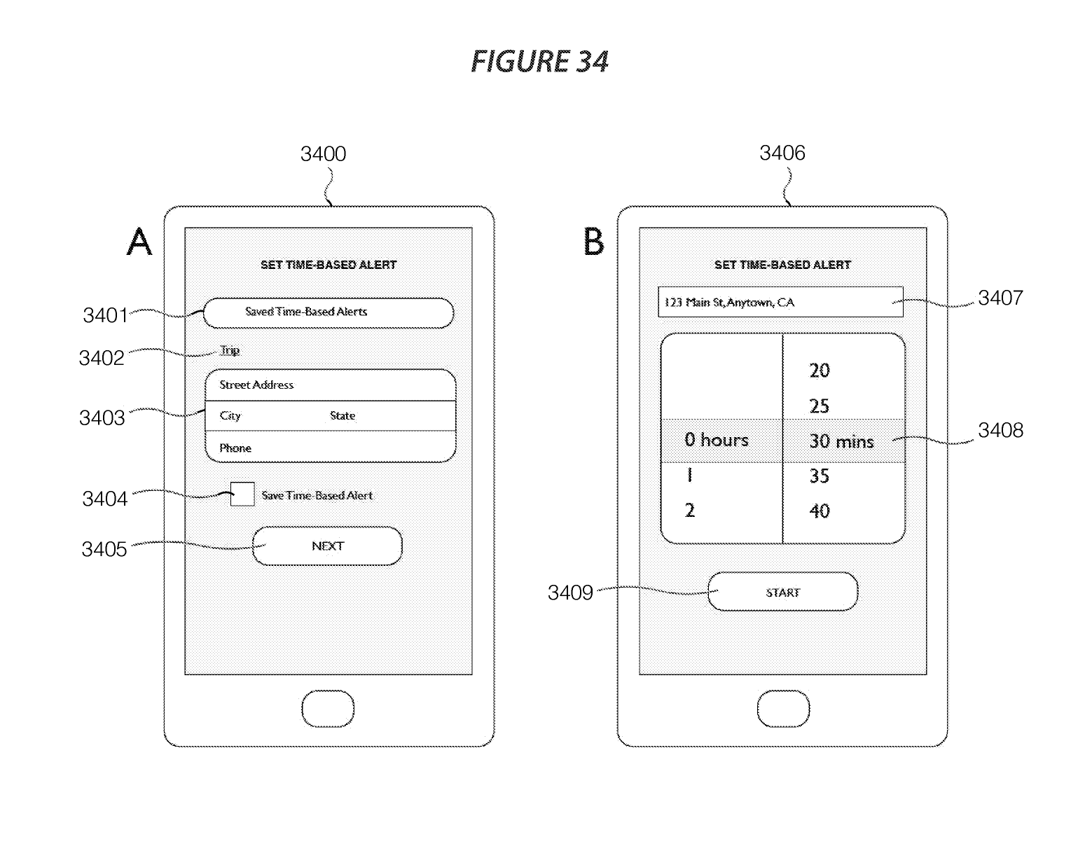

FIG. 34 is an exemplary illustration of two mobile device screenshots 3400, 3406 illustrating time-based alert settings associated with a fixed location. Screenshot “A” illustrates the following functions and elements: the capability to select from a list of saved timer alerts 3401, the capability to change the time-based location alert associated with a fixed location to a time-based location alert associated with a trip between two fixed locations 3402, the capability to input a specific location where the mobile user will be present for a predetermined time period 3403, the capability to save the time-based alert 3404, and a function 3405 to select a time period associated with the alert.

Furthermore, screenshot “B” illustrates the following functions and elements: the fixed location previously entered by the mobile user associated with the time-based alert being generated 3407 (entered in 3403), the capability to enter a specific time period that the mobile user estimates he or she will be present at the previously entered location 3408, and the capability to start a timer 3409 that when expired, will generate a visual prompt on the user's mobile device screen requesting that the user add additional time or dismiss the prompt.

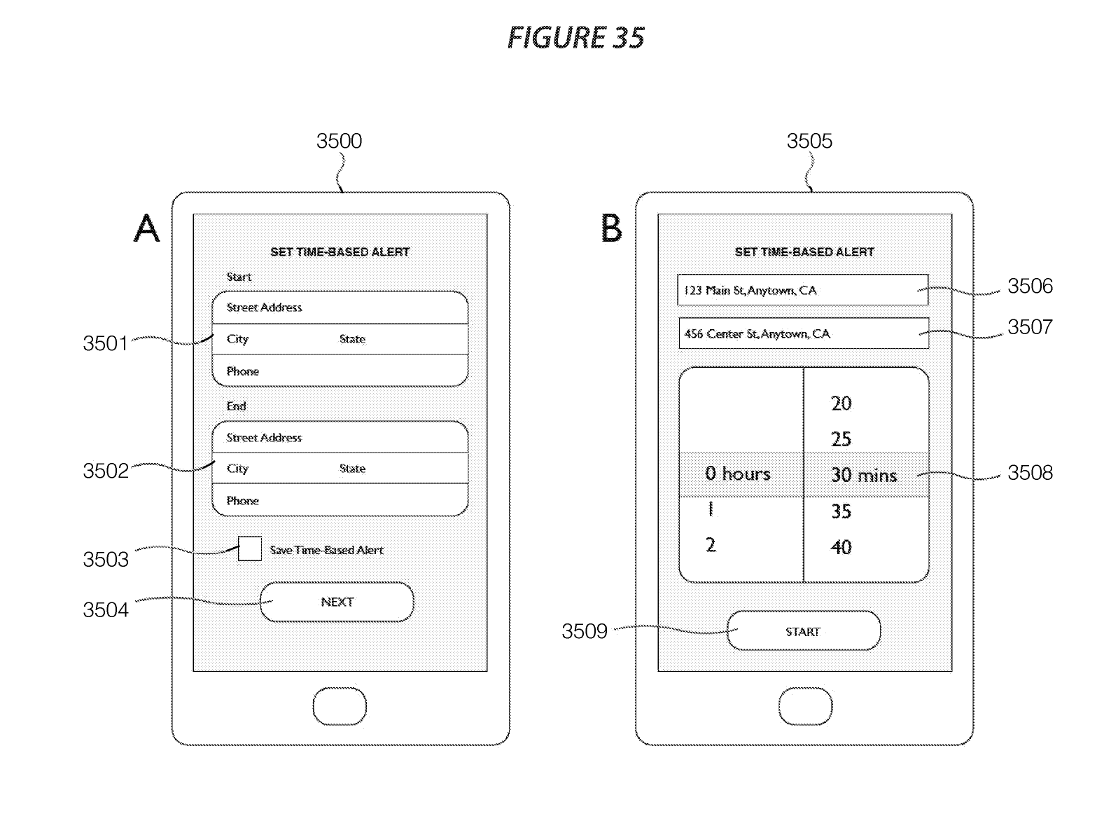

FIG. 35 is an exemplary illustration of two mobile device screenshots 3500, 3505 illustrating time-based alert settings associated with a trip between two fixed locations. In particular, screenshot “A” illustrates the following functions and elements: the capability to enter a specific location where a mobile user will begin 3501 and end a trip 3502, the capability to save the time-based location alert 3503, and the capability to select a time period associated with the alert 3504.

Likewise, screenshot “B” illustrates functions and elements: the fixed locations 3506, 3507 previously entered by the mobile user associated with the time-based alert being generated (entered in 3501, 3502), the capability to enter a specific time period 3508 that the mobile user estimates will be required to travel the distance between the aforementioned locations, and the capability to start a timer 3509 that generates a visual prompt on the user's mobile device screen requesting that the mobile user add additional time or dismiss the prompt or otherwise a location/timer based alert is transmitted to the network's alert server(s).

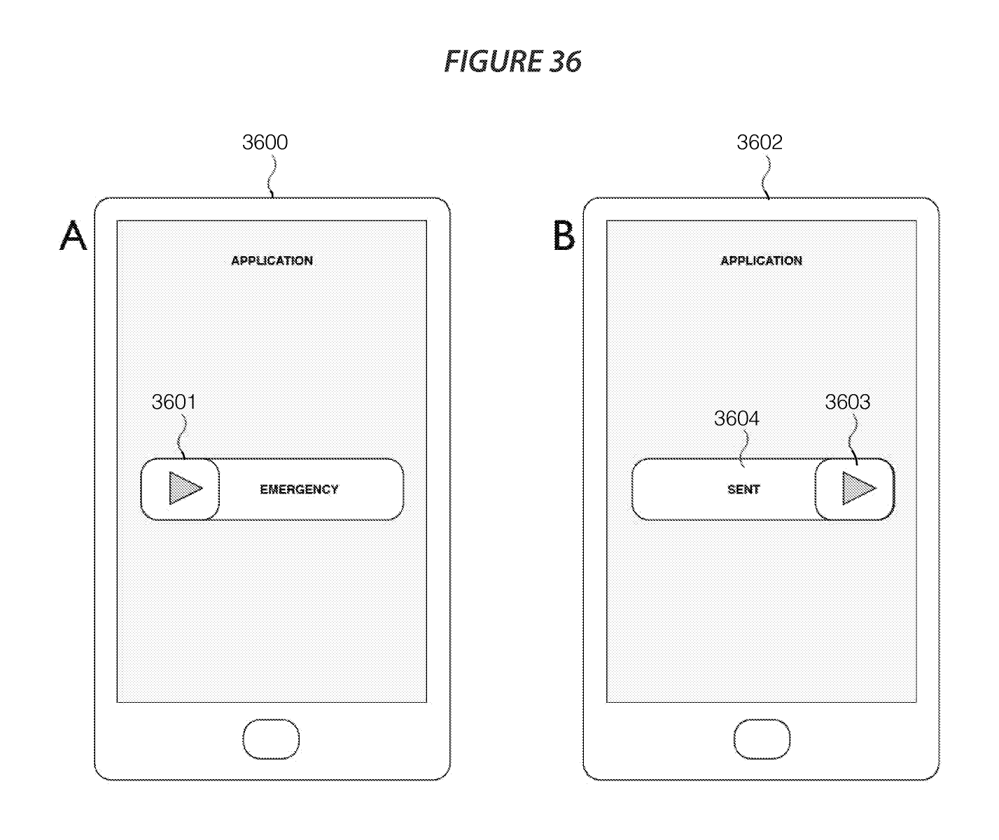

FIG. 36 is an illustration of two mobile device screenshots 3600, 3602 illustrating a manner of sending manual alerts. In particular, screenshot “A” illustrates the following functions and elements: the capability to generate a manually transmitted alert 3601. In some embodiments, a touch screen interface may be used to slide a button in a predetermined direction (e.g., rightward) to generate and transmit the alert.

Likewise, screenshot “B” illustrates the following functions and elements: the capability to manually generate an alert has been moved to the rightward position 3603. The illustration also shows a notification 3604 that the generated alert has been transmitted.

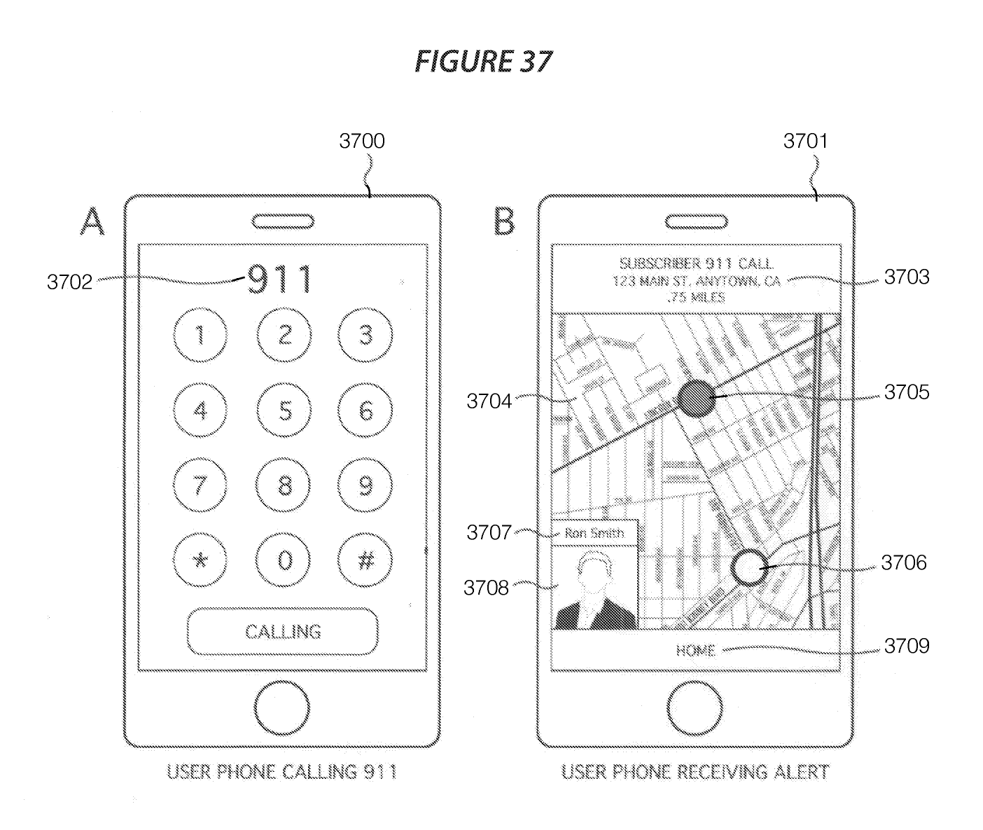

FIG. 37 is an exemplary illustration of two mobile device screenshots 3700, 3701 of a mobile user making a 9-1-1 calls and by using a keypad and a user mobile phone that receives an alert based on the 9-1-1 call. Illustration “A” shows a mobile device screen where the mobile user has dialed the emergency number 9-1-1 (3702) whereas illustration “B” shows a mobile device screen of a mobile user who has received an incoming, crowd-sourced alert from the mobile user of the mobile device depicted in illustration “A”.

The mobile device screen 3701 shown in illustration “B” shows a description of the incoming alert 3703 that includes the location associated with the nearby mobile user who generated the alert and the distance from that mobile user to the mobile user who received the alert. Furthermore, the embodiment shows a map associated with the location of the incident 3704, a visual representation of the mobile user's location on the map who generate the alert 3705, a visual representation of the mobile user's location who received the alert 3706, the identity of the mobile user who transmitted the alert 3707, a visual representation or picture of the mobile user who generated the alert 3708, and a mechanism to exit the displayed screen 3709.

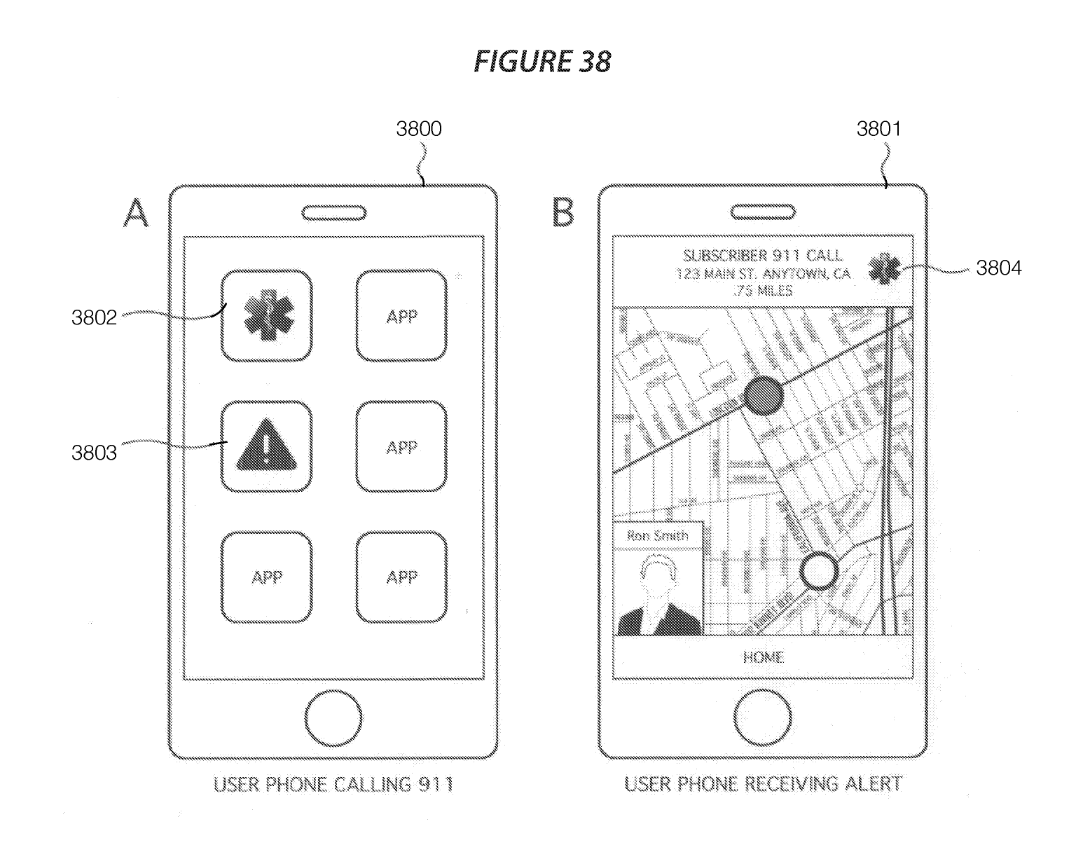

FIG. 38 is an exemplary illustration of two mobile device screenshots 3800, 3801 of a mobile user making a 9-1-1 call by selecting an emergency function and a mobile user mobile phone that receives an alert based on the 9-1-1 call. For example, a mobile user involved in a situation requiring the response of medical services, could utilize medical or safety application icons 3802, 3803 to automatically dial 9-1-1 and connect with an emergency communications center. FIG. 38, illustration “B”, shows an example of a screen that would display data related to the aforementioned subscriber alert, to include a visual or text indication that the alert 3804, was related to an incident where medical assistance is needed.

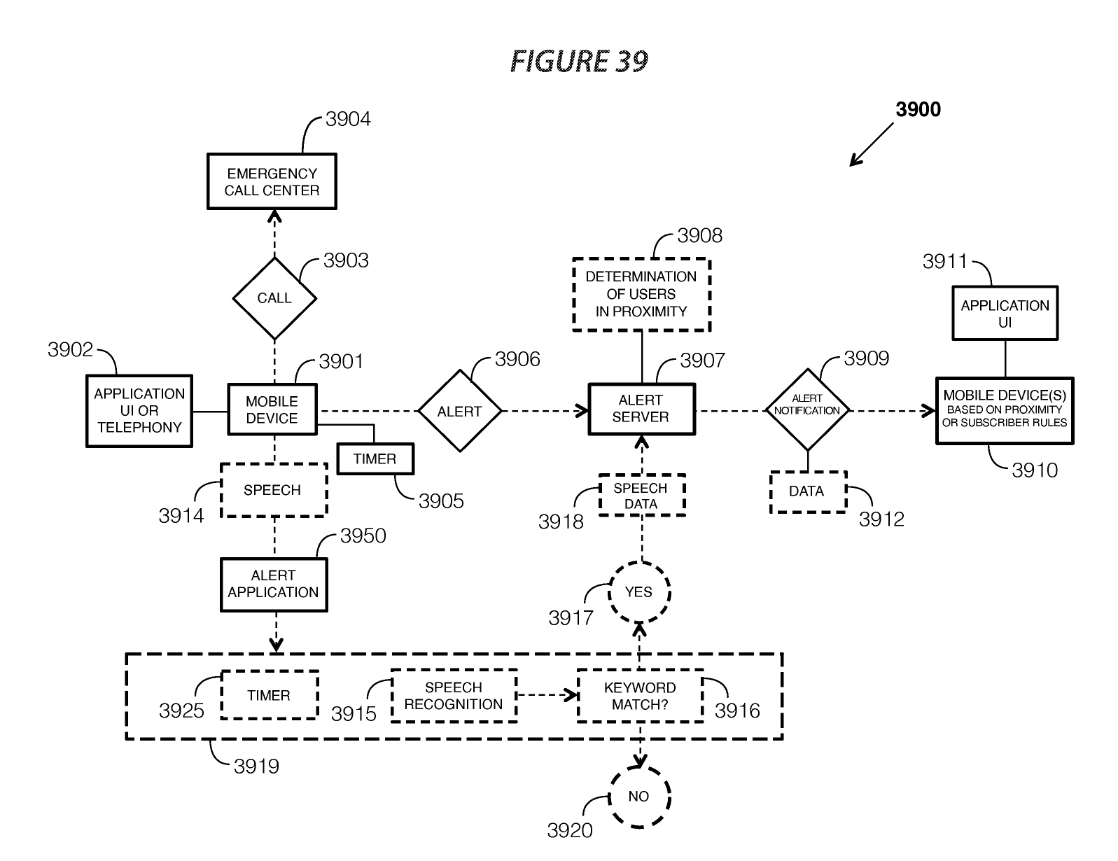

FIG. 39 is an exemplary layout illustrating the transmission of speech data, generated during a call with emergency assistance, on a network 3900 consistent with the present disclosure. As shown, mobile device 3901 may be equipped with speech-recognition technology (e.g., speech application 3919) to generate speech data during an emergency call. Speech application 3915 may be integrated within alert application 3950 or may be an unique software application accessible by, or under the control of, alert application 3950. Speech data may be transmitted to inform mobile users on the network about the nature of present emergency and safety-related incidents.

In some embodiments, speech application 3919 includes speech recognition 3915 and keyword matching 3916 modules. Speech recognition module 3915 may receive audio speech data and convert said speech data to text such that keyword matching module 3916 can determine whether a keyword is uttered during the call with emergency assistance. As speech applications are known in the art, mobile device 3901 may incorporate speech recognition hardware components known in the art integrated within mobile device 3902 such that speech application 3919 can recognize speech data 3918 and transmit such data 3918 to alert server 3907 for distribution to other mobile devices on the network according to proximity and subscriber rules.

For example, if mobile device 3901 is a mobile phone, speech recognition hardware known in the art may be integrated in both the speaker and receiver sub-components of the phone. Speech application 3919 may therefore detect keywords spoken on both sides of the call (i.e., the caller and the callee) to detect when the mobile user or emergency dispatcher utters a keyword during the emergency call 3902.

As such, if the result is TRUE (“YES” 3917) at keyword matching block 3916, the detected keyword(s) are transmitted by speech application 3919 (as speech data 3918) to the alert server 3907 to be distributed to other mobile devices on the network according to proximity and subscriber rules (block 3908). Alternatively, if the result at keyword matching block is FASLE (“NO” 3920), an update with speech data 3918 is not sent to alert server 3907.

Alert server 3907 generates alert notifications 3909 from the alerts 3906 and speech data 3918. The data 3912 within alert notifications 3909 may include speech data 3918, an incident ID, a time stamp of the alert transmission, the mobile user's ID, the location of the mobile device 3901 that transmitted the alert (e.g., GPS coordinates), and the alert type. The alert notifications 3909 are sent to other mobile devices on the network 3900 according to proximity and subscriber rules.

A mobile user may place an emergency call 3902 from the mobile device 3901 (e.g., via an application UI or the device's telephony software 3903) to emergency assistance (i.e., Emergency Call Center 3904). In some embodiments, once the call 3902 to emergency assistance is made, speech application 3915 is immediately enabled to detect “keyword(s)” within the mobile user's speech 3914 during the call 3902. In some embodiments, speech application 3919 begins “active listening” immediately after the mobile user places the call 3902 to emergency assistance regardless to whether an emergency dispatcher has yet connected on the call 3902.

Speech application 3919 may be configured to include a default list of keywords. The default list of keywords may include common emergency or medical-related words and phrases but the present disclosure is not limited thereto. For example, the default list of keywords may include “fire,” “crash,” “robbery,” “kidnapping,” “heart attack,” and “child abduction.” However, the default list of keywords is not limited to any particular set of words or phrases but may include other words and phrases than those included in the aforementioned list.

The settings of speech application 3919 may also be configured to include customized keywords which corresponds to specific incidents. For example, a store clerk may configure speech application 3919 to detect when “code 99” is uttered during an emergency call to indicate that shoplifting is occurring in the store.

Speech application 3919 may also be configured to include customized keywords by audibly entering the keyword(s) into a microphone component of the mobile device 3901. During the configuration process, the mobile user may also provide the translation of each customized keyword so once an alert is generated based on its detection, the translation is additionally included within the alert notification or update.

Speech application 3919 may be further configured to detect keywords in various languages such as English, Spanish, Dutch, or Mandarin. However, the present disclosure is not limited to any particular language and may include other language(s) than those previously mentioned.

In some embodiments, speech application 3919 includes a timer 3925. Speech application 3919 may use timer 3925 to effect active listening for a predetermined time period. For example, speech application 3919 may effect active listening for 5, 10, 20 seconds or any configured time period immediately after the mobile user initiates a call to Emergency Call Center 3901 to determine whether any keywords are uttered during the call.

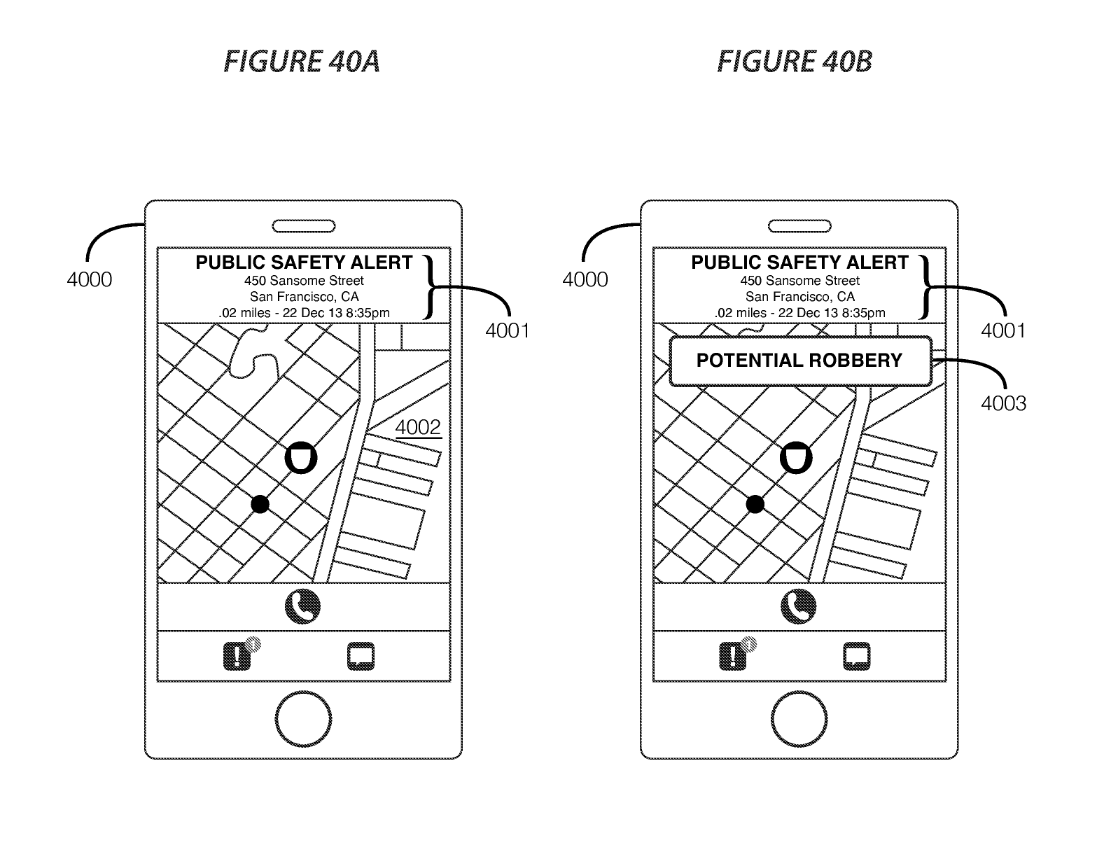

FIGS. 40A and 40B show illustrations of an interface of an alert application in operation on a mobile device 4000 displaying a public safety alert message 4001. Public Safety Alert message 4001 informs a mobile user on the network that a safety or emergency incident is occurring at 450 Sansome Street, San Francisco, Calif. In addition, the alert application interface may also display a visual map of the area 4002 where the emergency incident is occurring along with an indication of the recipient's location in relation thereto.

FIG. 40B shows speech data 4003 (i.e., “Potential Robbery”) that provides additional information regarding the nature of the incident. As previously described, speech data 4003 may be generated by a speech application contained within or under the control of the alert application. In some embodiments, speech data 4003 may be included within the initial Public Safety Alert message 4001 while in other embodiments, speech data 4003 may be included in an update alert after an initial alert notification is dispatched.

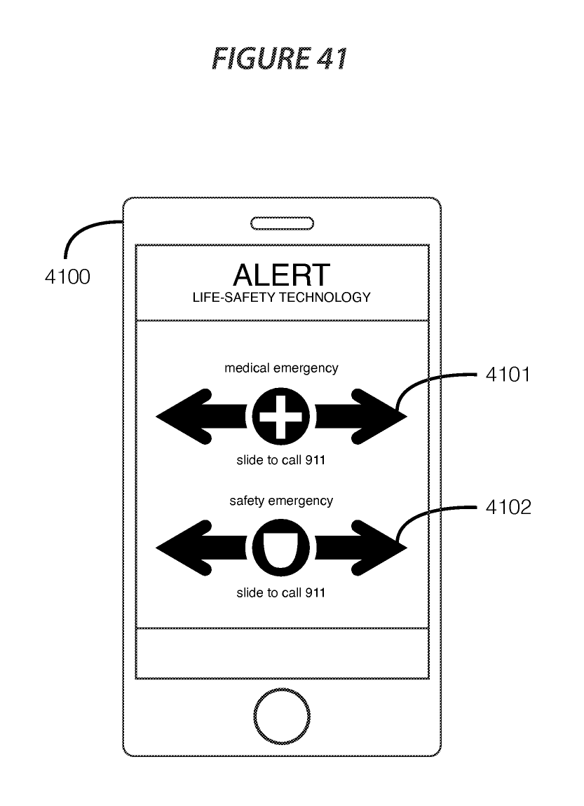

Moving forward, FIG. 41 illustrates an interface of an alert application in operation on a mobile device 4102 used to contact emergency assistance. In some embodiments, a mobile user may select medical and safety emergency functions 4101, 4102 via a sliding gesture (to the right or left) to contact emergency assistance. In the embodiment shown, activating either medical or safety emergency function 4101, 4102 initiates a 9-1-1 call.

Transmitting speech data throughout a mobile network may be achieved in alternative manners than previously described. For example, if a mobile user selects the medical emergency function 4101 to initiate a call to emergency assistance, a speech application begins “active listening” for keywords. Advantageously, the speech application may begin “active listening” immediately after the mobile user selects either medical or safety emergency functions 4101, 4102 and before emergency assistance personnel gets on the call.

During the call with emergency assistance, when the speech application detects a keyword, the mobile phone sends speech data (e.g., in the form of an update alert) to the alert server to be distributed to mobile devices on the network according to proximity and subscriber rules. In the event that the speech application detects several keywords during the call, several update alerts related to the incident may be transmitted to the alert server.

In another example, speech data may be transmitted over the mobile network immediately after a mobile user dials emergency assistance by using the mobile phone's 4100 keypad (not shown). In this example, in the event a keyword is uttered during the call, the mobile device 4100 sends an update alert to the alert server each instance that a keyword is detected.

In yet another example, speech data may be dispatched after a pre-determined time period after the call is initiated by the mobile user. As such, the initial alert may include context data (e.g., medical or safety), speech data (detected during the pre-determined time period), an incident ID, a time stamp of the alert transmission, the mobile user's ID, the location of the mobile device 4100 that transmitted the alert (e.g., GPS coordinates), and the alert type. Similarly, using the keypad, once a call to emergency assistance is made, the speech application may listen for keywords for a pre-determined time period and afterwards the mobile device may send an alert with the detected speech data (if any), an incident ID, a time stamp of the alert transmission, the mobile user's ID, the location of the mobile device 4100 that transmitted the alert (e.g., GPS coordinates), and the alert type.

Further, the speech application may listen for keywords during the entirety of the call and afterwards send an alert with speech data based on an algorithm. For example, if the speech application detects several keywords during the call, an algorithm initiated by the speech application may determine the frequency of each keyword uttered during the call and thereafter incorporate the keyword(s) within the alert(s) according to pre-defined rules.

For instance, if a first keyword is detected more often than a second keyword by a pre-defined margin of occurrences, the speech application may only include the first detected keyword in the alert. In some embodiments, the alert is generated by the mobile device 4100 and transmitted to the alert server after the call with emergency assistance has concluded.

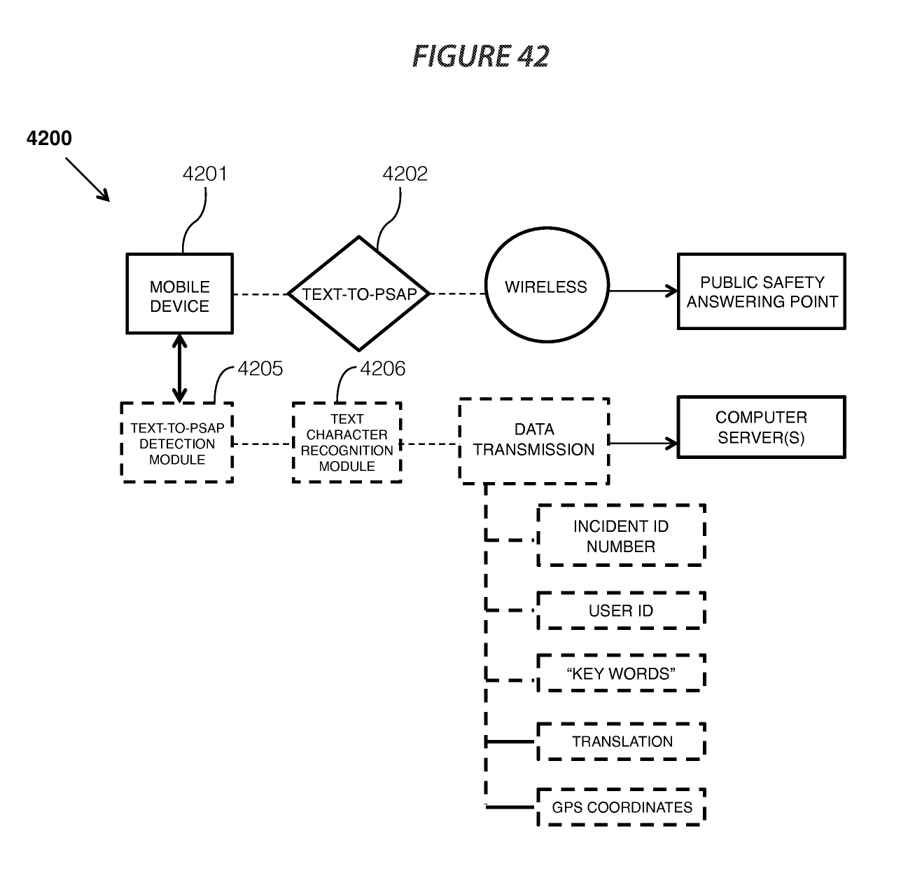

FIG. 42 is an exemplary layout 4200 illustrating the transmission of data when a mobile user contacts emergency assistance via a text message function using mobile device 4201. In some implementations, a text to emergency assistance service, such as a text-to-PSAP 4202 application, may be used to send emergency messages to a Public-Safety Answering Point (PSAP). In some embodiments, the alert application installed on the mobile device 4201 detects via text-to-PSAP detection module 4205 when a text-to-911 function is initiated on the mobile device 4201. Upon detection, text character recognition module 4206 checks for keywords and subsequently an alert is generated by the mobile device 4201 and transmitted to the alert server(s) on the network. In some implementations, the entire text-to-911 message is included in the alert. In other implementations, only the keyword(s) detected (e.g., via text character recognition module 4206) within the text-to-PSAP message is included in the alert.

The preceding Description and accompanying Drawings describe example embodiments in some detail to aid understanding. However, the scope of the claims may cover equivalents, permutations, and combinations that are not explicitly described herein.

1. A method, comprising:
detecting at least one keyword spoken during a phone call with emergency assistance;
generating an alert based on the phone call wherein the alert includes the at least one keyword; and
transmitting the alert to at least one computer server.

2. A computer readable medium including code, when executed, causing a mobile device to:
detect at least one keyword in a text message transmitted by a mobile device to emergency assistance;
generate an alert based on the text message wherein the alert includes the at least one keyword; and
transmit the alert to at least one computer server.

3. A method, comprising:
receiving a notification of an alert on a first mobile device according to proximity and subscriber rules;
wherein the notification of the alert includes speech data related to a safety or medical incident.

4. (canceled)
